(19) United States
(12) Patent Application Publication
(10) Pub. No.: US 2013/0125008 A1
(43) Pub. Date: May 16, 2013

(54) Systems And Methods For Providing Content Streams

(71) Applicant: Stremor Corporation, Scottsdale, AZ (US)

(72) Inventor: William Irvine, Scottsdale, AZ (US)

(73) Assignee: Stremor Corporation, Scottsdale, AZ (US)

(21) Appl. No.: 13/678,267

(22) Filed: Nov. 15, 2012

Related U.S. Application Data
(60) Provisional application No. 61/560,199, filed on Nov. 15, 2011.

(51) Int. Cl. G06F 3/0482

(52) U.S. Cl. CPC G06F 3/0482
USPC 715/739

(57) ABSTRACT

Various embodiments can concern a method of organizing and displaying two or more content elements. The method can include: receiving a first content element from one or more users; creating a parent content stream for the first content element; displaying the parent content stream to the one or more users; after displaying the parent content stream, receiving one or more second content elements from the one or more users, the one or more second content elements are related to the first content element; perform content analysis of the one or more second content elements; determining whether to create one or more child content streams from the parent content stream based at least partially upon the content analysis of the one or more second content elements; creating based at least partially upon the content analysis of the one or more second content elements at least one of: the one or more child content streams or one or more orphan content streams; and displaying to the one or more users the parent content stream and the at least one of the one or more child content streams and one or more orphan content streams. Other embodiments are disclosed.

### CROSS-REFERENCE TO RELATED APPLICATIONS

This application claims the benefit of U.S. Provisional Application No. 61/560,199, filed Nov. 15, 2011. U.S. Provisional Application No. 61/560,199 is incorporated herein by reference.

### FIELD OF THE INVENTION

This invention relates generally to methods and systems of displaying content and relates more particularly to methods and systems configured to display and organize content elements in an online environment.

### DESCRIPTION OF THE BACKGROUND

One of the main uses of the Internet is for a user to share ideas and debate topics online. To facilitate online discussions, website operators have created computer discussion forums where a user posts a content element and other users can post replies, comments, etc. on the original content element.

Within the context of an active and organically growing environment of both professionally produced and user-generated content that allows for replies and comments, the organization of subsequent content elements that stray “off topic” or that generate related topics has long been a significant problem for experienced and new users alike. Since the early days of pre-web bulletin board systems and services such as CompuServe and America Online (AOL), the discussion format has not properly allowed for the natural and semantic evolution of conversations that stray, in varying degrees, from the primary initial topic.

Various attempts have been made to address the issue, with varying degrees of success and most often failure. The two primary methodologies currently employed by systems allowing for user-generated commentary and conversations are the “tree format” and “quotation system” solutions. Both solutions have significant shortcomings.

The tree format, as illustrated in FIG. 1, is typically seen in some venues where the primary user base are early adopters of online discussion systems, or are more technologically savvy in nature. It relies on a very tall page of content, where user comments are contain within indented blocks of text, with vertical lines drawn to indicate which block of text represents a posting that is a user-generated response to another specific posting. Popular websites using such an implementation are Slashdot.org and Reddit.com with varying degrees of modifications. The intention is to organize the display of replies in relation to the posting that inspired the reply.

The quotation system, illustrated in FIG. 2, is often seen in more traditional discussion board implementations such as vBulletin by Internet Brands, Inc. of El Segundo, Calif., Invision Power Board by Invision Power Services, Inc. of Forest, Va., and others. These systems rely on a user including all or portions of the post for which the user is authoring a reply within an indented (or otherwise differently styled) block of text and included in their reply posting. The intention is to alert the reader to the comments of one user, which has inspired the reply of another.

Both solutions have significant shortcomings. The tree format often requires significant scrolling by the reader in order to follow the flow of one specific branching off of a discussion, then more scrolling by the reader back to the top to pick up where the reader left off. The quotation system often displays an inordinate amount of repeated text and comments within the context of a chronologically sequential discussion of several pages, interspersed with fragments of branched-off discussions on every page.

A third solution that was typical of older-styled discussion systems, and now seen only within the comments sections of some sites such as Digg.com, is to sequentially indent each direct reply to the comment before it. The result can quickly become difficult to read as just a few replies may result in an indented text area so narrow, as to create a column where only a few words fit on each line.

The result of these attempted solutions deliver a discussion format that can quickly become difficult to follow for experienced users, and impossible to comprehend for new and inexperienced users or readers.

Additionally, within the context of a mobile platform accessed by users on smart phones and mobile tablets, the rapid and accurate classification of newly posted content is critical to the awareness and acceptance of the content. As is often the case, users are interested in quickly disseminating information to as many people as possible, with as little effort as possible—primarily due to the limitations of their devices.

As an example, the Twitter® platform by Twitter, Inc. of San Francisco, Calif. is a widely accepted and commonly used method to “tweet” short messages about anything that the user feels is important. However, the Twitter® platform is limited to messages of 140 characters with no integrated options for classification or categorization of what is being posted beyond the username of the person “tweeting.” The person may have said something vitally important to thousands of people, but it will often go completely unnoticed.

Additionally, micro-blogging social platforms such as the Twitter® platform and social media platforms such as the Facebook® platform by Facebook, Inc. of Menlo Park, Calif. have no methodology to rank the real or probable value and importance of the content being posted by their users. This deficiency creates an additional barrier to understanding what is or may be important to the larger base of users, or even the entire world of online content consumers. Without a metric to assess the value of new content, contextually targeted advertising based on content valuation is impossible.

In response to the shortcomings of the Twitter® platform, the service has added the option of “hash tags” that may be included in the 140 character postings, but this addition can be confusing and unpredictable in usage. For example, a tag such as “#TRANSFORMERS” may indicate the posting has content that relates to a movie, the popular toy, a comic book, a television cartoon, or even a brand of eyeglasses. Third-party technology solutions attempt to categorize and interpret these hash tags to provide a means to understand the context of new and historical postings, but it relies on the accuracy of tag usage by users.

Within the Facebook® platform, the system also relies on proper voluntary categorization by its users, who rarely attempt to categorize the content they post beyond the identity of who posted it. For example, a “news feed” on the Facebook® platform is composed of the recent postings of all the friends one is following and all the persons or groups to which one has subscribed. The feed is a disorganized and ever-changing mixture of disassociated topics, ideas, and comments. And in fact, one may see within her feed a reply from a friend to an unseen posting made by someone they have not “friended.”

And in both cases of these currently popular platforms, an emphasis is placed on the relative value of the registered users—how many people have “friended” a person on the Facebook® platform or who are “following” a person on Twitter® platform—placing the priority of vanity over the priority of content. As a result, important contributions from those less popular will be missed by nearly all.

A real world example of these shortcomings in the categorization and valuation of content is as follows: a user of the Twitter® platform has just watched the Transformers movie titled, “Dark Of The Moon,” is dissatisfied, and wants to inform the public that it should avoid the new movie; so the user creates a “tweet” on the Twitter® platform using the hash tag “#TDOTM” with their negative review. In order for anyone to be aware of the negative review, they must have searched on the “TDOTM” hash tag, or have been following the user on the Twitter® platform.

Accordingly, a need or potential for benefit exists for an apparatus or system that allows for easy display and organization of a discussion in an online environment.

### BRIEF DESCRIPTION OF THE DRAWINGS

To facilitate further description of the embodiments, the following drawings are provided in which:

FIG. 1 illustrates a prior art tree format method of displaying content elements;

FIG. 2 illustrates a prior art quotation method for displaying content elements;

FIG. 3 illustrates an example of a box diagram of a computer system for processing content from one or more users, according to an embodiment;

FIG. 4 illustrates an example of a content stream, according to an embodiment;

FIG. 5 illustrates an example of a parent content stream with an original content element and subsequent content elements;

FIG. 6 illustrates an example of a content stream family that includes a parent content stream and a child content stream.

FIG. 7 illustrates an example of a content stream family that includes a parent content stream, multi-generational child content streams, and orphan content streams;

FIG. 8 illustrates an example of a content stream database of FIG. 3;

FIG. 9 illustrates a flow chart for an example of a method of organizing and displaying two or more content elements, according to an embodiment;

FIG. 10 illustrates an example of an interface that can be used to receive content elements from the user of FIG. 3;

FIG. 11 illustrates a flow chart for an exemplary embodiment of an activity of creating a parent content stream, according to an embodiment;

FIG. 12 illustrates a flow chart for an exemplary embodiment of a procedure of performing initial content analysis of the first content element, according to an embodiment;

FIG. 13 illustrates an example of a word cloud and text used to create another word cloud, according to an embodiment;

FIG. 14 illustrates an example of a title generated based upon the text and the word cloud of FIG. 13, according to an embodiment;

FIG. 15 illustrates an example of categories, according to an embodiment;

FIG. 16 illustrates a flow chart for an exemplary embodiment of an activity of performing content analysis of the new content element, according to an embodiment;

FIG. 17 illustrates an exemplary mobile interface configured to display content elements, according to an embodiment;

FIG. 18 illustrates an example of a first navigation process between content elements on a computing device with a touchscreen, according to an embodiment;

FIG. 19 illustrates an example of a navigation process between content elements on a computing device without a touchscreen, according to an embodiment;

FIG. 20 illustrates an example of a second navigation process between content elements on the computing device of FIG. 18, according to an embodiment;

FIG. 21 illustrates an example of an interface of a computing device with a stream map, according to an embodiment;

FIG. 22 illustrates an example of a computer that is suitable for implementing an embodiment of computer system of FIG. 3; and

FIG. 23 illustrates a representative block diagram of an example of the elements included in the circuit boards inside chassis of the computer of FIG. 22.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

The terms “couple,” “coupled,” “couples,” “coupling,” and the like should be broadly understood and refer to connecting two or more elements or signals, electrically, mechanically and/or otherwise. Two or more electrical elements may be electrically coupled but not be mechanically or otherwise coupled; two or more mechanical elements may be mechanically coupled, but not be electrically or otherwise coupled; two or more electrical elements may be mechanically coupled, but not be electrically or otherwise coupled. Coupling may be for any length of time, e.g., permanent or semi-permanent or only for an instant.

### DETAILED DESCRIPTION OF EXAMPLES OF EMBODIMENTS

Some embodiments concern a method of processing information from one or more users using one or more computer processors. The method can include: receiving one or more first content elements from the one or more users, each of the one or more first content elements comprises one or more first components; using the one or more computer processors to perform an initial content analysis of the one or more first content elements to give a first weight to each of the one or more first components of the one or more first content elements; using the one or more computer processors to assign a first content value score to the one or more first content elements at least partially based upon the first weight assigned to each of the one or more first components of the one or more first content elements; receiving one or more second content elements from the one or more users; using the one or more computer processors to assign a second content value score to the one or more second content elements; using the one or more computer processors to modify the first content value score based upon one or more factors related to the one or more second content elements; using the one or more computer processors to determine a relationship between the one or more first content elements and the one or more second content elements; using the one or more computer processors to create a first arrangement of the one or more first content elements and the one or more second content elements at least based upon the relationship between the one or more first content elements and the one or more second content elements, the first content value score of the one or more first elements, and the second content value score of the one or more second content elements; and displaying the one or more first content elements and the one or more second content elements to the one or more users using the first arrangement.

Other embodiments can concern a system for processing content from one or more users. The system can include: a user interaction module configured to be performed by at least one computer processor and further configured to communicate with the one or more users and receive one or more first content elements and one or more second content elements; an initial content analysis module configured to be performed by the at least one computer processor and further configured to perform an initial content analysis of the one or more first content elements to assign a first weight to each of one or more first components of the one or more first content elements; an initial content valuation module configured to be performed by the at least one computer processor and further configured to assign content value scores to the one or more first content elements at least partially based upon the first weight assigned to each of the one or more components of one or more first content elements; an ongoing content analysis module configured to be performed by the at least one computer processor and further configured to perform an initial content analysis of the one or more second content elements to assign a second weight to each of one or more second components of the one or more second content elements; an ongoing content valuation module configured to be performed by the at least one computer processor and further configured to modify the content value score of a first element of the one or more first content elements at least partially based upon the second weight of each of the one or more second components of the one or more second content elements and one or more other factors related to the one or more second content elements and further configured to assign content value scores to the one or more second content elements; and a content display module configured to be performed by the at least one computer processor and further configured to determine a first arrangement of the one or more first content elements at least partially based upon the content value scores of the one or more first content elements, the content value scores of the one or more second content elements, and a relationship between the one or more first content elements and the one or more second content elements. The user interaction module is further configured to display the one or more first content elements to the one or more users based upon the first arrangement.

Various embodiments can concern a method of organizing and displaying two or more content elements using one or more computer processors. The method can include: receiving a first content element from one or more users; creating a parent content stream for the first content element; displaying the parent content stream to the one or more users; after displaying the parent content stream, receiving one or more second content elements from the one or more users, the one or more second content elements are related to the first content element; performing content analysis of the one or more second content elements; determining whether to create one or more child content streams from the parent content stream based at least partially upon the content analysis of the one or more second content elements; creating based at least partially upon the content analysis of the one or more second content elements at least one of: the one or more child content streams or one or more orphan content streams; and displaying to the one or more users the parent content stream and the at least one of the one or more child content streams and one or more orphan content streams.

In various embodiments, the systems and methods described herein provides users with a minimalist interface for the posting of new content streams that integrates back-end technology to analyze the submission, and automatically define the proper categorization and a predicted value metric. The result is a well-defined new piece of digital content that may be accessed by all other users through a hierarchal menu and/or search system, as well as a valuation prediction which may be used by targeted advertising systems.

The systems and methods described herein can handle discussions in online user-generated venues differently than the prior art methods, as that of a branching stream with tributary conversations that may be entirely different topics than that of the originating stream. Additionally, the systems and methods described herein can treat each comment, or posting, as a self-contained element of the entire stream so that organic and evolutionary organization of the elements may be more readily achieved by a variety of programmatically achieved solutions.

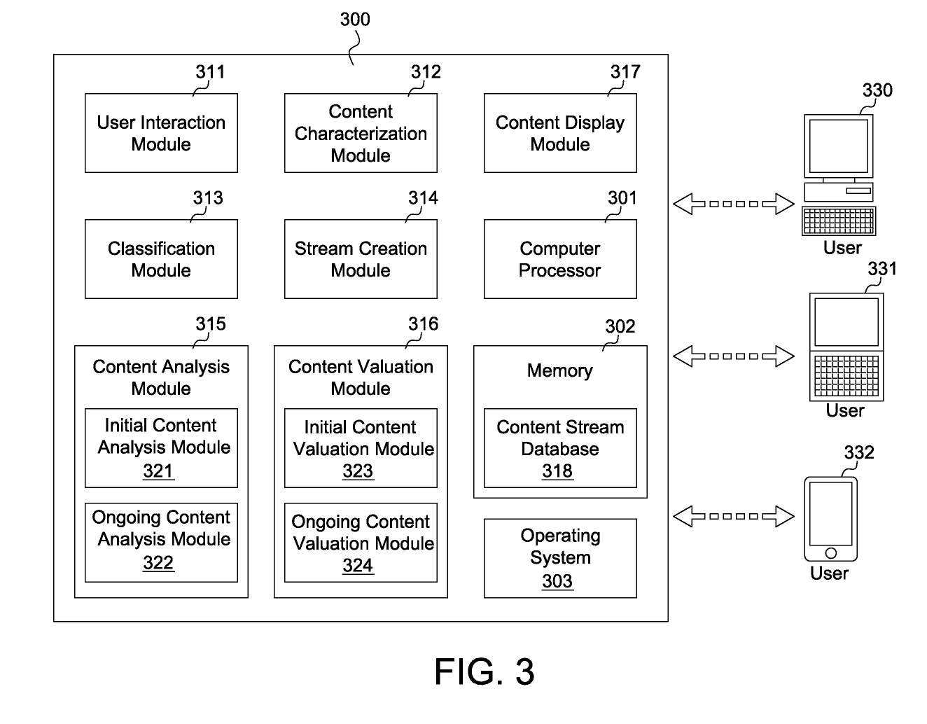

FIG. 3 illustrates an example of a box diagram of a computer system 300 for processing content from one or more users 330, 331, and 332, according to an embodiment. Computer system 300 is merely exemplary and is not limited to the embodiments presented herein. Computer system 300 can be employed in many different embodiments or examples not specifically depicted or described herein. In some examples, the content or a content stream can include one or more parent content elements and one or more child content elements.

In the embodiment shown in FIG. 3, computer system 300 can include: (a) an user interaction module 311 configured to communicate with users 330, 331, and 332 and further configured to receive the parent content elements and child content elements from users 330, 331, and 332; (b) a content characterization module 312 configured to determine a classification of parent elements and child content elements; (c) a classification module 313 configured to determine a relationship between the parent content element and the child content elements; (d) a stream creation module 314 configured to create a parent content stream for the parent content element and one or more child content streams for the one or more child content elements at least partially based upon the relationship between the parent content element and the child content elements; (e) a content analysis module 315; (f) a content valuation module 316; (g) a content display module 317 configured to determine a first arrangement of the parent content stream(s) and the child content stream(s) at least partially based upon the relationship between the parent content element and the child content elements; and (h) a content stream database 318. In the same or different embodiments, computer system 300 can also include at least one computer processor 301, memory 302, and operating system 303.

User interaction module 311, content characterization module 312, classification module 313, stream creation module 314, content analysis module 315, content valuation module 316, content display module 317 can be stored in non-volatile memory 302 and configured to run on or be performed using computer processor 301. In the same or different examples, content stream database 318 can be stored in memory 302.

User interaction module 311 is further configured to display the parent content streams and/or elements and the child content streams and/or elements to users 330, 331, and/or 332 based upon a first arrangement.

Content analysis module 315 can include: (a) an initial content analysis module 321 configured to perform an initial content analysis of the parent content elements to assign a first weight to each of the one or more components of the parent content elements; and (b) an ongoing content analysis module 322 configured to perform an initial content analysis of the child content elements to assign a second weight to each of the one or more components of the child content elements.

Content valuation module 316 can include: (a) an initial content valuation module 323 configured to assign content value scores to the parent elements at least partially based upon the first weight assigned to each of the one or more components of the parent content elements; and (b) an ongoing content valuation module 324 configured to modify the content value score of the parent content elements at least partially based upon the second weight of each of the one or more components of the child content elements and one or more other factors related to its child content elements. Ongoing content valuation module 324 can also determine the content value score of one or more child content elements.

“Computer System 300,” as used herein, can refer to a single computer, single server, or a cluster or collection of servers. Typically, a cluster or collection of servers can be used when the demands by client computers (e.g., users 330, 331, and 332) are beyond the reasonable capability of a single server or computer. In many embodiments, the servers in the cluster or collection of servers are interchangeable from the perspective of the client computers.

In some examples, a single server can include user interaction module 311, content characterization module 312, classification module 313, stream creation module 314, content analysis module 315, content valuation module 316, and content display module 317. In other examples, a first server can include a first portion of these modules. One or more second servers can include a second, possibly overlapping, portion of these modules. In these examples, computer system 300 can comprise the combination of the first server and the one or more second servers.

Content stream database 318 can be a structured collection of records or data, for instance, which is stored in non-volatile memory 302. For example, content stream database 318 stored in memory 302 can be an XML (Extensible Markup Language) database, MySQL database, or an Oracle® database. In the same or different embodiments, content stream database 318 could consist of or comprise a searchable group of individual data files stored in memory 302.

In various embodiments, operating system 303 can be a software program that manages the hardware and software resources of a computer and/or a computer network. Operating system 303 performs basic tasks such as, for example, controlling and allocating memory, prioritizing the processing of instructions, controlling input and output devices, facilitating networking, and managing files. Examples of common operating systems for a computer include Microsoft® Windows, Mac® operating system (OS), UNIX® OS, and Linux® OS. Common operating systems for a mobile device include the iPhone® operating system by Apple Inc. of Cupertino, Calif., the Blackberry® operating system by Research In Motion (RIM) of Waterloo, Ontario, Canada, the Palm® operating system by Palm, Inc. of Sunnyvale, Calif., the Android operating system developed by the Open Handset Alliance, the Windows Mobile operating system by Microsoft Corp. of Redmond, Wash., or a Symbian operating system by Nokia Corp. of Espoo, Finland.

As used herein, “computer processor” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions.

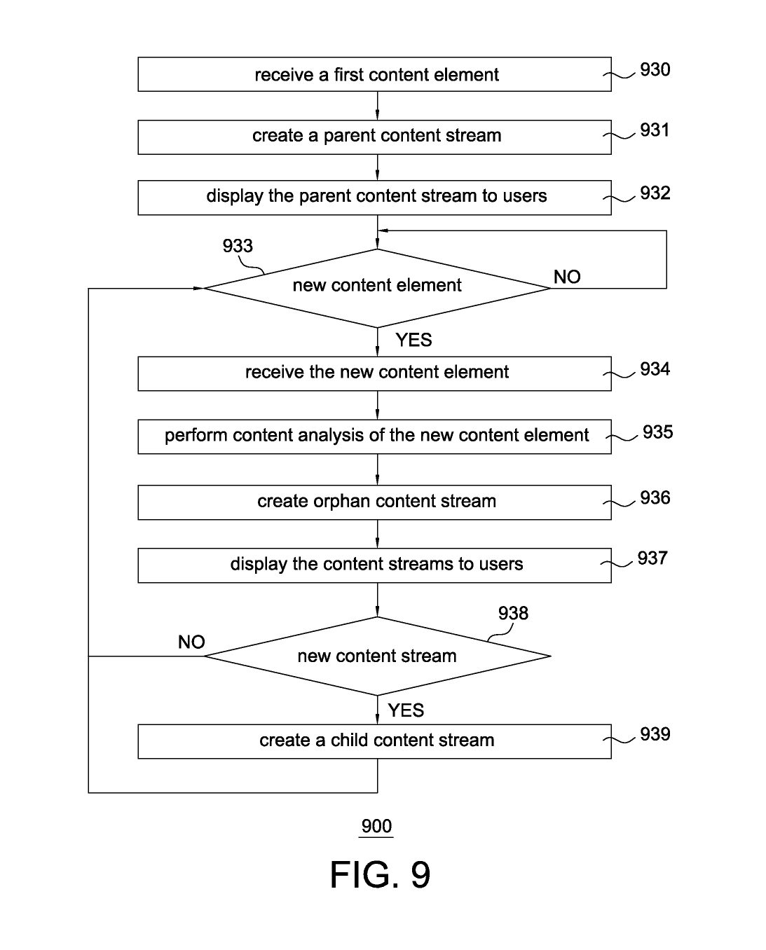

Computer system 300 and method 900 (FIG. 9) by which the embodiments described here are implemented are as varied as the programming languages available to developers. Nothing described herein defines a process or methodology specific to one particular programming language, platform, framework, or operation system. In one exemplary embodiment described herein, computer system 300 and method 900 (FIG. 9) can be implemented on a platform that involves a server running a Linux® OS, with access to a MySQL database, and that uses the Python application development language.

Computer system 300 is configured to create an online discussion forum using a branching system that makes it easier for a user of the online discussion forum of an original discussion stream and/or one or more child, secondary, “off-topic,” and/or tributary discussions that can result from the original discussion stream.

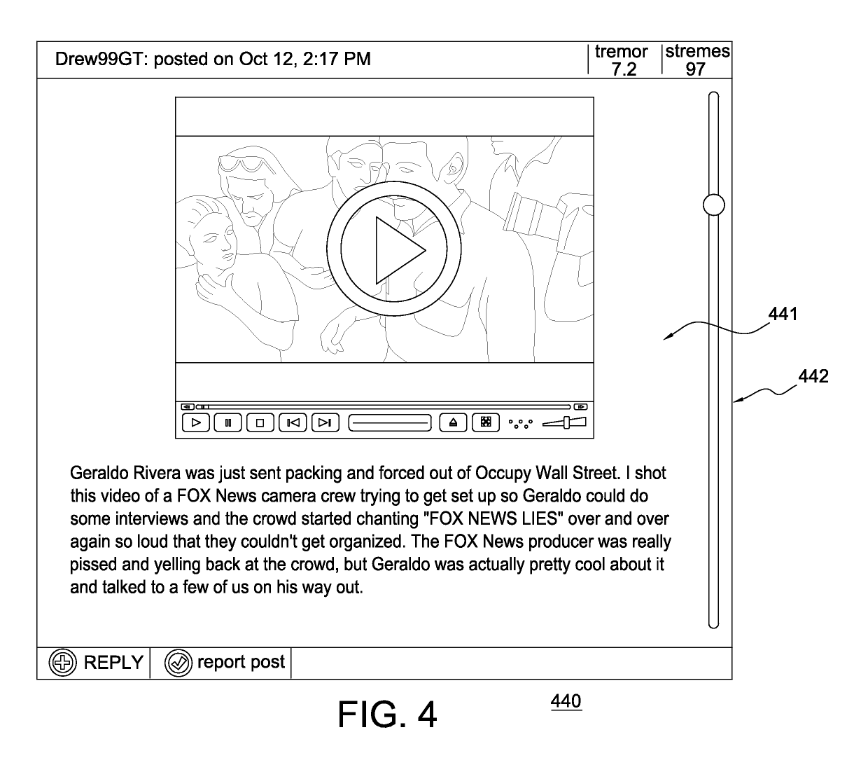

FIG. 4 illustrates an example of a stream 440, according to an embodiment. As shown in FIG. 4, each posting, or comment submitted to a stream 440, including the opening post or original content element 441 used to initiate a topic stream, can be a unique item, typically displayed by itself on a card or window 442. Additional information will typically be displayed such as the author of the posting, items to reward the author for a highly-regarded posting, items to reply to the author's posting, and possibly additional other items.

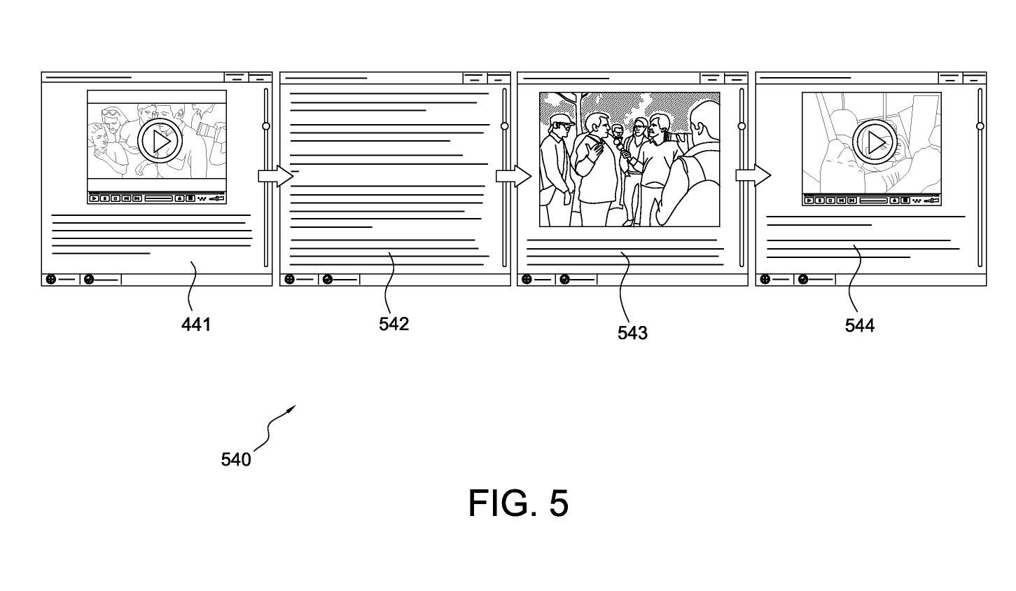

FIG. 5 illustrates an example of parent stream 540 with original content element 441 and subsequent content elements 542, 543, and 544. As shown in FIG. 5, upon submission of original content element 441 to create a new content stream, the new content stream is consider a “parent stream,” which is comprised of a collection of content elements (e.g., content elements 441, 542, 543, and 544) that make up the discussion contained by parent stream 540. The arrangement and display of a stream of content elements will depend on the device of the user (computer, tablet, smart phone, etc.), and the design of the presentation layer and/or graphical user interface.

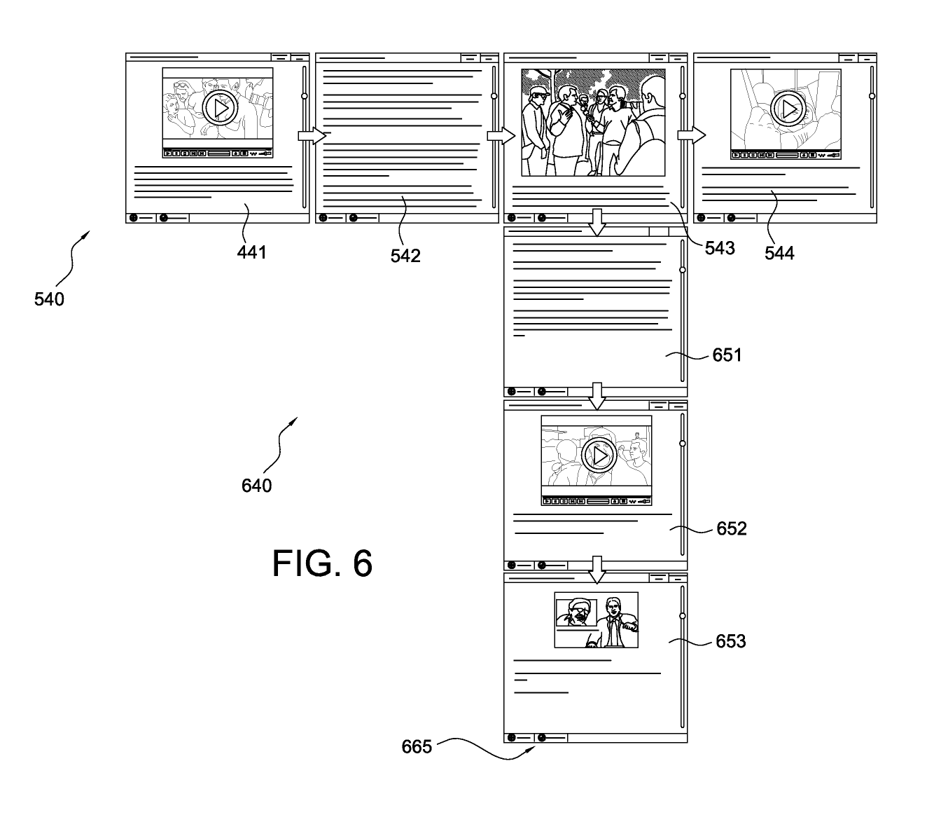

FIG. 6 illustrates an example of a stream family 640 that includes parent content stream 540 and child content stream 655. As shown in FIG. 6, a sequence of replies that breaks off from the main parent stream, or parent stream 540, generates a subordinate child content stream, or child content stream 665, that is attached—at the point of the break—to the main parent stream, parent content stream 540. In the example shown in FIG. 6, the parent stream includes content elements 441, 542, 543, and 544. Subordinate child content stream includes content elements 543, 651, 652, and 653. Child content stream 665 breaks off from parent content stream 540 at content element 553.

In some embodiments, if a user opts to reply directly to the author of a specific content element, and another user subsequently replies to that new content element, a child stream of two content elements has been created. As a child stream inspires more replies and comments from users, computer system 300 (FIG. 3) can identify the new child stream as requiring its own headline, word-cloud, and other parameters that define content streams within computer system 300 (FIG. 3).

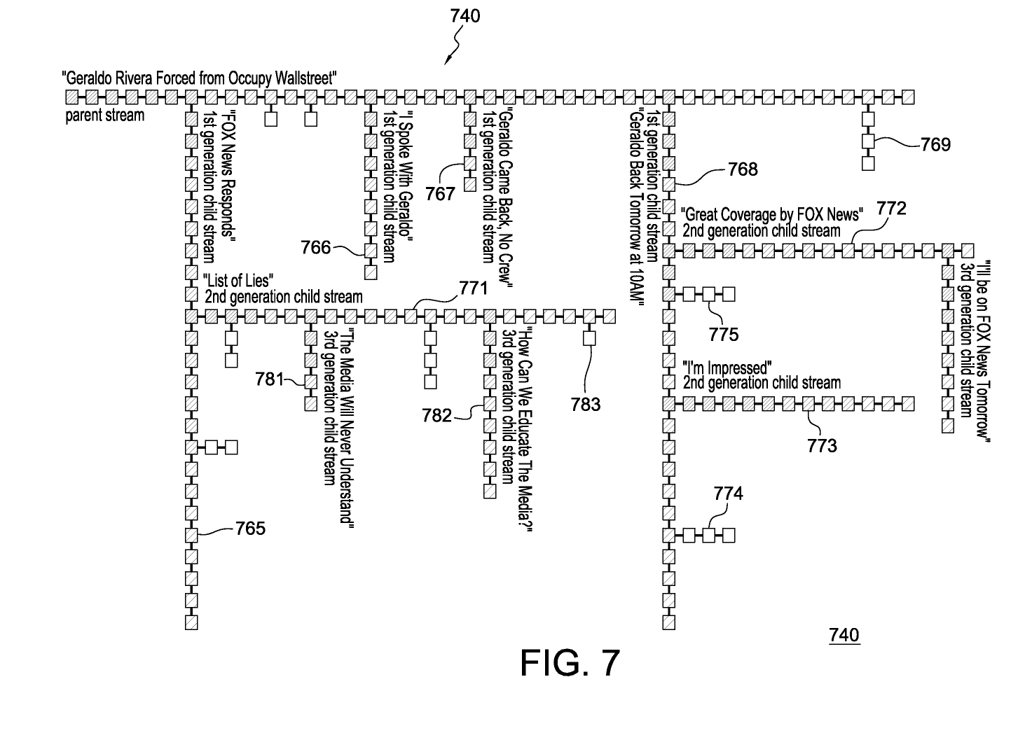

FIG. 7 illustrates an example of a parent content stream 740 that includes parent content stream 740, multi-generational child content streams 765, 766, 767, 768, 771, 772, 773, 781, and 782, and orphan content streams 769, 774, 775, and 783. As shown in FIG. 7, in the event of a highly popular topic, with additional popular child streams, it is possible that several generations of child streams can develop as the conversation evolves on parent content stream 740, as well as on several child content streams 765, 766, 767, and 768, and even new child streams 772, 773, 774, 781 and 782 branching off of other child content streams 765 and 768. Parent content stream 740 represents the structure of content elements within the fully realized concept of computer system 300 (FIG. 3) and method 900 (FIG. 9): multi-threaded relational user-generated content streams.

FIG. 7 also shows a structural representation of several untitled orphan content streams 769, 774, 775, and 783 that represent a series of branching replies that have no yet received status as a child stream. Stream creation module 314 (FIG. 3) identifies and ranks the priority and probability of a series of branching replies to determine the point at which those replies are identified by a new unique child stream.

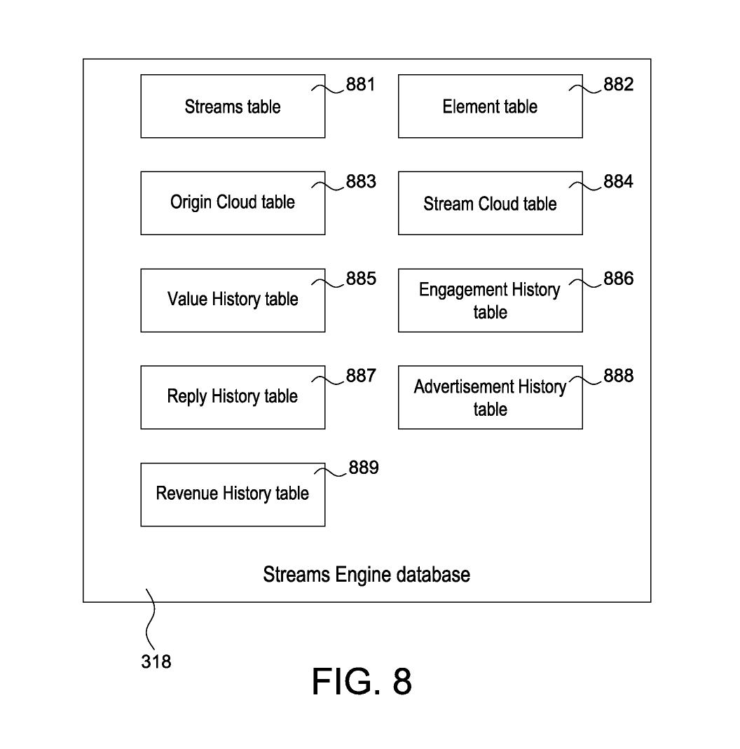

As is the case with any system featuring user-generated or real-time dynamic content, a database with efficient schema can be used not only for implementation, but also for effective delivery of the final product to a large-scale audience. In some embodiments, content stream database 318 (FIG. 3) can include database tables and columns. FIG. 8 illustrates an example of a content stream database 318. In some embodiments, content stream database 318 can include the following tables:

STREAMS: streams table 881 can contain columns that define the core attributes of each content stream. In this embodiment, the columns used can include:

stream_id: a unique identifier for each content stream;

Stream_hdln: the headline of the content stream;

origin_date: a time stamp identifying the date and time of creation;

last_reply: a time stamp identifying the date and time of the last reply;

origin_cloud: a unique identifier relative to the origincloud table;

stream_cloud: unique identifier relative to the streamcloud table;

act_value: the assigned and evolving actual value score;

rel_value: the relative and evolving value score (1-10);

value_i: the initial relative value score (1-10);

views_s: the total number views by logged-in users;

views_n: the total number of views by general readers;

replies_n: the total number of replies by logged-in users;

replies_h: the total number of replies by highly-ranked users;

replies_a: the total number of replies by sponsored users;

boost_num: the total number of user boosts;

boost_num_h: the total number of boosts by highly-ranked users;

reduce_num: the total number of user reduces;

stream_ads: the total number of distinct ads targeted to the stream;

stream_act: the total number of ad actions by stream readers;

stream_rev: the total of advertising revenue generated by the stream;

ch_main: the identifier referencing the main or top channel;

ch_pri: the identifier referencing the primary sub-channel;

ch_sec: the identifier referencing the secondary sub-channel;

ch_ter: the identifier referencing the tertiary sub-channel; and

other fields necessary for the management of content streams.

ELEMENTS: Element table 882 can contain the content (posting) of stream elements. In this embodiment, the columns used are:

element_id: a unique identifier for each content element;

parent_id: the identifier parent content stream, if any;

stream_id: the identifier for stream that contains the element;

reply_id: the identifier for the element that inspired this content element;

stream_array: an array of all multigenerational streams, if any; and

orphan_id: a unique identifier establishing orphan status, if any.

ORIGINCLOUD: Origin Cloud table 883 contains the word cloud associated with the parent content element of a content stream. In this embodiment, the columns used can include:

origin_id: a unique identifier for each cloud;

origin_post: the identifier for the database record of the opening post;

origin_stream: the identifier for the database record of the stream; and

o_cloud: an associative array containing the origin word cloud.

STREAMCLOUD: Stream cloud table 884 contains the evolutionary word cloud associated with the content of an entire stream. In this embodiment, the columns used can include:

scloud_id: a unique identifier for each cloud;

stream_id: the identifier for the database record of the stream; and

s_cloud: an associative array containing the stream word cloud.

VALUEHISTORY: Value History table 885 contains the historic value for each content stream in the system for the entire life of each content stream. In this embodiment, the columns used can include:

his_id: a unique identifier for each value record;

day: a datetime field indicated the date of the day the value was calculated;

stream_id: the identifier for the database record of the stream; and

value: the stream's value at the time of calculation, indicated by day field.

ENGHISTORY: Engagement history table 886 contains the historic total daily views (engagement) for each stream in the system, for the entire life of the stream. In this embodiment, the columns used can include:

his_id: a unique identifier for each value record;

day: a datetime field indicated the date of the day the value was calculated;

stream_id: the identifier for the database record of the stream; and

stream_views: the number of views for the day indicated by the day field.

REPHISTORY: Reply history table 887 contains the historic total daily stream replies for each stream in the system, for the entire life of the stream. In this embodiment, the columns used can include:

his_id: a unique identifier for each value record;

day: a datetime field indicated the date of the day the value was calculated;

stream_id: the identifier for the database record of the stream; and

replies: the number of replies for the day indicated by the day field.

ADHISTORY: Advertisement history table 888 contains the historic total of in-stream ad views for each stream in the system, for the entire life of the stream. In this embodiment, the columns used can include:

his_id: a unique identifier for each value record;

day: a datetime field indicated the date of the day the value was calculated;

stream_id: the identifier for the database record of the stream; and

views: the number of ad views for the day indicated by the day field.

REVHISTORY: Revenue history table 889 contains the historic total of ad revenue generated for each stream in the system, for the entire life of the stream. In this embodiment, the columns used can include:

his_id: a unique identifier for each value record;

day: a datetime field indicated the date of the day the value was calculated;

stream_id: the identifier for the database record of the stream; and

revenue: the total revenue generated on the day indicated by the day field.

These database tables can define the core intelligence behind computer system 300 (FIG. 3), and while the described example uses a MySQL database using InnoDB and MYIASM tables, other database technologies can be used in other examples.

Referring again to FIG. 3, upon submission of a new opening post for a content stream by one of users 330, 331, or 332 via user interaction module 311, content characterization module 312 can initialize all necessary tables with the new stream identifiers, and inserts appropriate initializing variables into streams table 831 (FIG. 8). Next, content characterization module 312 can the new record in the elements table 882 (FIG. 8) can be initialized and all appropriate content and initializing variables can be inserted.

As replies are received in the growth of a parent stream, new records are created in element table 882 (FIG. 8) with the unique identifier of the parent stream inserted into the stream_id column.

FIG. 9 illustrates a flow chart for an embodiment of a method 900 of organizing and displaying two or more content elements. Method 900 can also be considered a method creating a parent content stream for the first content element and/or a method of threading two or more content streams. In some examples, method 900 can also be considered a method of processing information from one or more users using one or more computer processors and/or a method of advertising. Method 900 is merely exemplary and is not limited to the embodiments presented herein. Method 900 can be employed in many different embodiments or examples not specifically depicted or described herein.

In some embodiments, the activities, the procedures, and/or the processes of method 900 can be performed in the order presented. In other embodiments, the activities, the procedures, and/or the processes of method 900 can be performed in any other suitable order. In still other embodiments, one or more of the activities, the procedures, and/or the processes in method 900 can be combined or skipped.

Referring to FIG. 9, method 900 includes an activity 930 of receiving a first content element. Referring back to FIG. 3, in some examples, one of users 330, 331, or 332 can use a computing device to enter and/or transmit the first content element to computer system 300. In many examples, the first content element is transmitted to computer system 300 from user 330, 331, or 332 over the Internet or another computer network.

In various embodiments, computer system 300 can generate and/or display one or more web pages and/or other interfaces that user 330, 331 or 332 can use to submit or send the first content element to computer system 300.

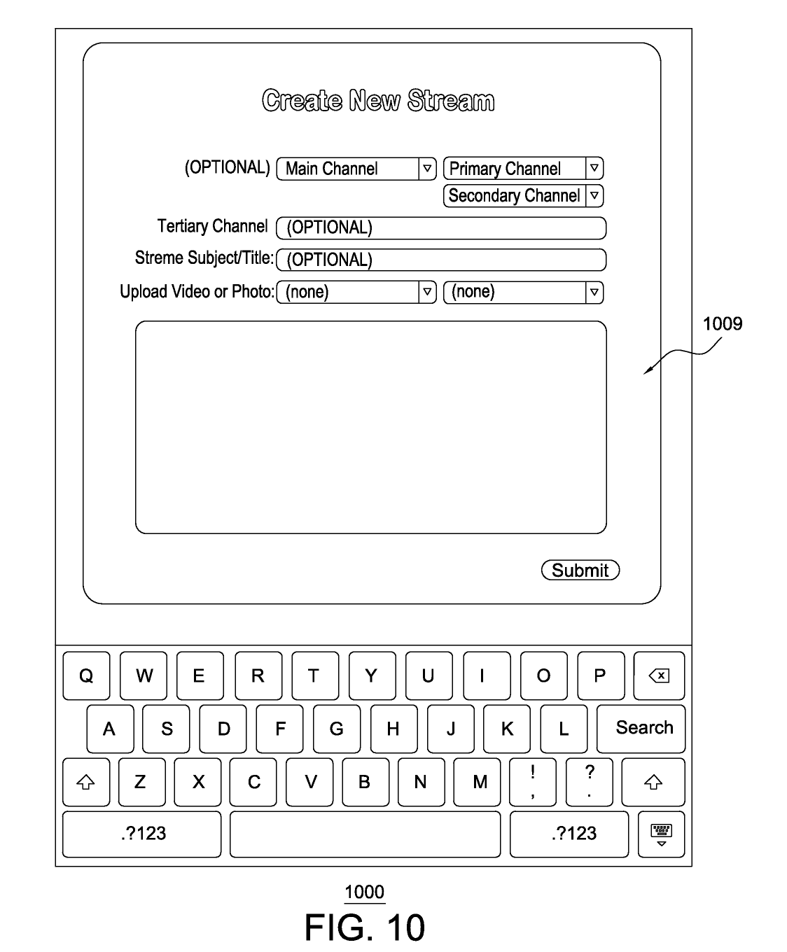

FIG. 10 illustrates an example 1000 of interface 1009 that can be used to receive content elements from user 330, 331 or 332 (FIG. 3). In some embodiments, users interested in expediency of submitted new content, or who are on devices with limited screen space such as smart phones, are provided interface 1009 for the creation of new content. Interface 1009 provides for the entry of their content, any attached photos, or videos, as well as an ability to self-define appropriate categories.

User interaction module 311 (FIG. 3) can receive the first content element from user 330, 331, or 332 (FIG. 3). In some examples, the first content element can include text, audio-video, and/or images. The first content elements include one or more components. In some embodiments, the one or more components can include one or more words.

In the same or different examples, user interaction module 311 (FIG. 3) can also receive information about the first content element (e.g., the source of the first content element, identification of the submitter, identification of the author of the first content element, one or more keywords for the first content element, date of creation of the first content element, a summary of the first content element, description and/or commentary on the first content element, name(s) of actors or people shown in the first content element, and/or the length of the first content element if the first content element is audio or audio-visual element). In some embodiments, the information about the first content stream can be considered a component of the first content element.

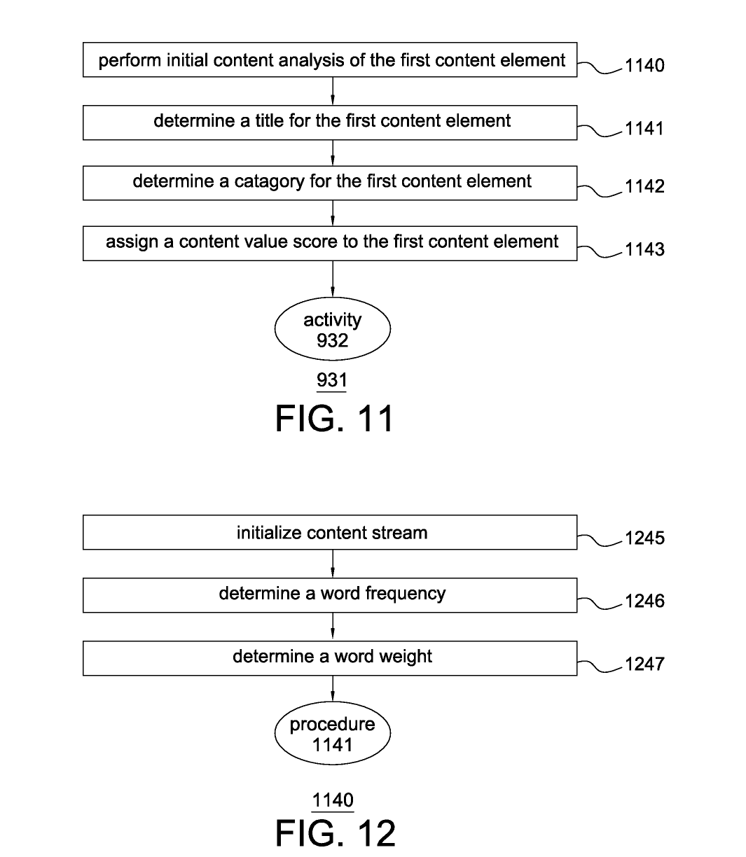

Method 900 in FIG. 9 continues with an activity 931 of creating a parent content stream. Referring again to FIG. 3, stream creation module 314 can create the parent content stream. FIG. 11 illustrates a flow chart for an exemplary embodiment of activity 931 of creating a parent content stream, according to the first embodiment.

Referring to FIG. 11, activity 931 includes a procedure 1140 of performing an initial content analysis of the first content element. FIG. 12 illustrates a flow chart for an exemplary embodiment of procedure 1140 of performing the initial content analysis of the first content element, according to an embodiment.

Referring to FIG. 12, procedure 1140 includes a process 1245 of initializing the content stream. Initial content analysis module 321 (FIG. 3) can initialize all necessary tables with the new stream identifiers, and can insert appropriate initializing variables into streams table 881 (FIG. 8).

Next, procedure 1140 of FIG. 12 includes a process 1246 of determining a word frequency. In some examples, initial content analysis module 321 (FIG. 3) can determine the word frequency. In some embodiments, initial content analysis module 321 (FIG. 3) can determine the word frequency by counting the number of occurrences of each word in the content stream. Depending on the type of media that comprises the first content element, determining the word frequency can include analyzing the components of the first content element. For example, initial content analysis module 321 (FIG. 3) can analyze the text that comprises the content element, the text describing the content element, one or more keywords provided by the user, and/or other information about the first content element.

Subsequently, procedure 1140 of FIG. 12 includes a process 1247 of determining a word weight. In some embodiments, initial content analysis module 321 (FIG. 3) can perform a natural language analysis of at least a portion of the words in the first content element to determine the word weight. In some examples, other information available to initial content analysis module 321 (FIG. 3) (e.g., user supplied data or location information) can be used to determine the word weight.

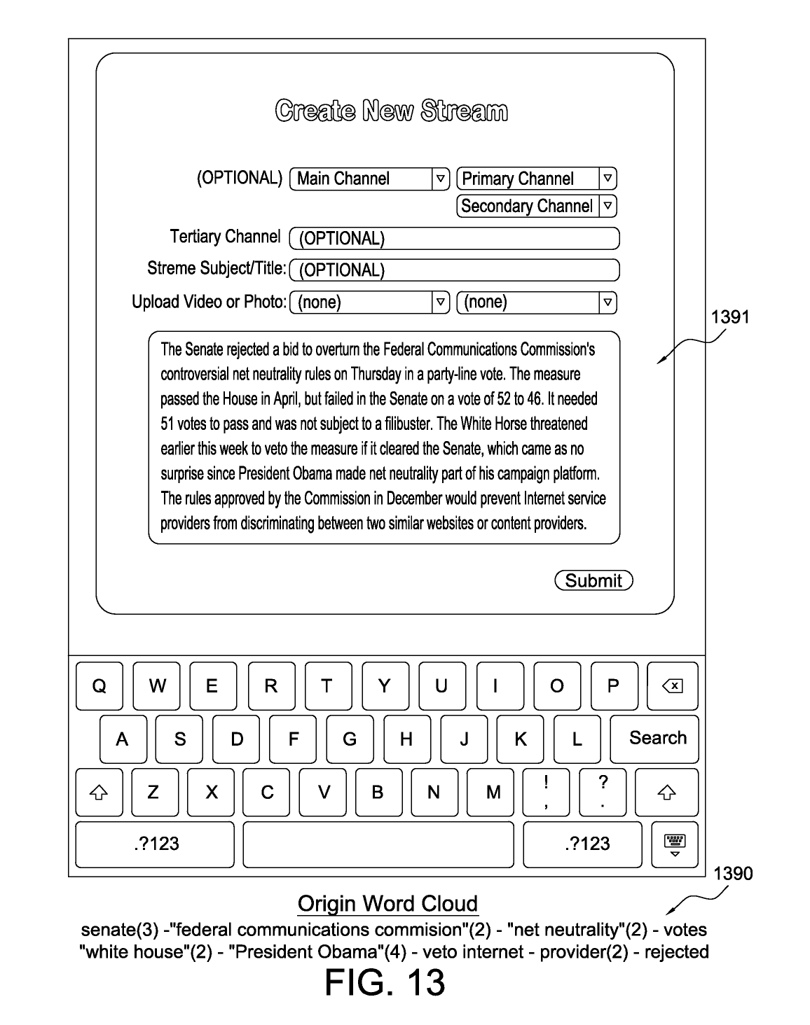

In some embodiments, initial content analysis module 321 (FIG. 3) can create a word cloud as part of process 1247. Creating a word cloud for the first content element provides the first weight for each of the one or more components of the first content element. For example, initial content analysis module 321 (FIG. 3) can review the submitted content and can create a word cloud that ranks the frequency and importance of the words used in the submission text. Often-repeated words are given higher weight while proper noun words that describe persons, places, or important things such as news organizations are also given a high score in the weighting process. The resulting word cloud is classified as the “origin word cloud” that signifies the word cluster used to create the new content stream. FIG. 13 illustrates an example of a word cloud 1390 and text 1391 used to create word cloud 1390, according to an embodiment. After process 1247, procedure 1140 of FIG. 12 is complete.

Referring again to FIG. 11, activity 931 in FIG. 11 continues with a procedure 1141 of determining a title for the content element. In some examples, initial content analysis module 321 (FIG. 3) can determine a title for the content element. In some embodiments, initial content analysis module 321 (FIG. 3) can determine the title at least partially based upon the first weight assigned to each of the one or more components of the content element.

In the same or different embodiment, initial content analysis module 321 (FIG. 3) at least partially uses a title provided by user 330, 331, or 332 (FIG. 3) to determine the title. In other examples, initial content analysis module 321 (FIG. 3) uses only the title provided by user 330, 331, or 332 and, if no title is provided, then determines a title for the first content element.

In some embodiments, initial content analysis module 321 (FIG. 3) can apply a natural language analysis to the opening sentence of the submission, applying additional weight to any words appearing in the origin word cloud (specified as the title sub-cloud), and assigning potential titling value to words in the opening sentence. The result of the analysis creates an appropriate headline for the new stream in a syntax designed for easy readability amongst a list, group, or other arrangement of multiple headlines.

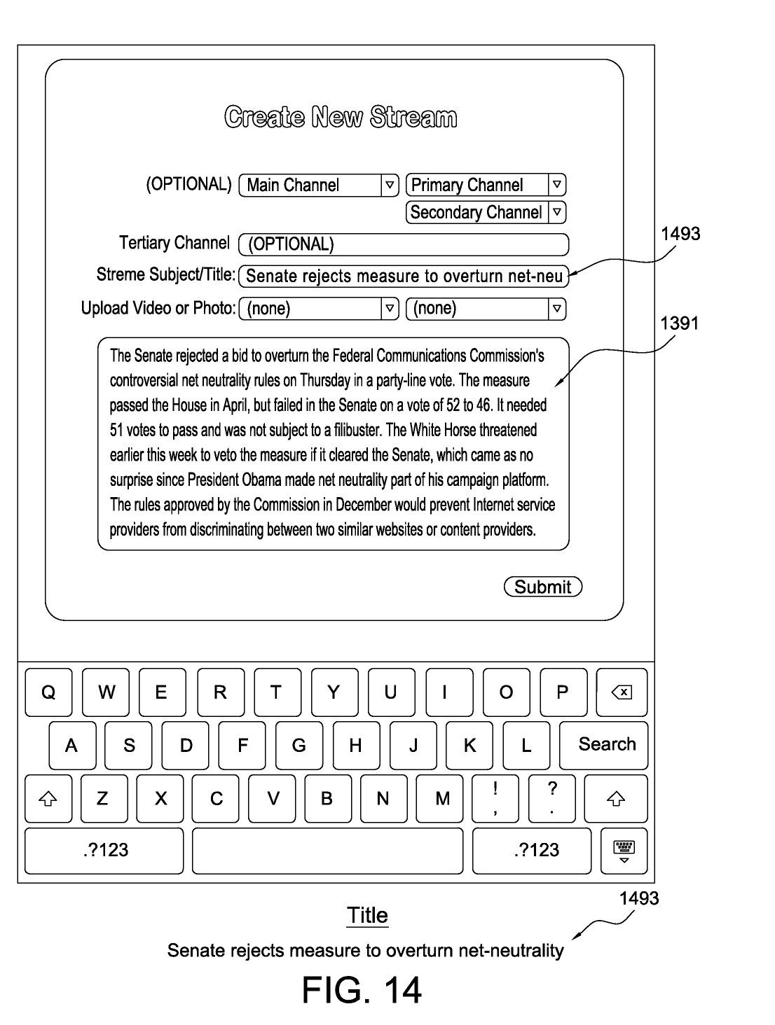

For example, one method for auto-generating an effective title or headline for the new content stream involves initial content analysis module 321 (FIG. 3) first extracting the initial sentence of the opening post, and comparing that against the origin word cloud using a Natural Language Toolkit (NLTK). The “titling routine” uses existing comparative logic in the NLTK to extract unnecessary words, adjectives, or other modifiers to generate a condensed but readable headline that properly represents the crux of the submission. Once generated, the completed headline can be presented to the content author for confirmation or editing, before being inserted into streams table 881 (FIG. 8). FIG. 14 illustrates an example of a title 1493 generated based upon text 1391 and word cloud 1392 (FIG. 13), according to an embodiment.

Subsequently, activity 931 of FIG. 11 includes a procedure 1142 of determining at least one category for the first content element. In some examples, initial content analysis module 321 (FIG. 3) can determine at least one category for the first content elements at least partially based upon the first weight assigned to each of the one or more components of the content element. In the same or different embodiment, initial content analysis module 321 (FIG. 3) at least partially uses categories provided by user 330, 331, or 332 (FIG. 3) to determine the categories. In other examples, initial content analysis module 321 (FIG. 3) can use the category provided by user 330, 331, or 332 (FIG. 3) as the category for the first content element.

One method for automatically determining the best “location” or category for a new content stream, submitted without indicating target channels, within a hierarchal assembly of topical channels involves an analysis of the origin cloud and stream headline using the NLTK against an evolving database of corpora for each existing content channel in streams table 881 (FIG. 8). This exemplary process is combined with additional data points such as the geographic location of the content author, analysis of the content of linked material, status of the content author (reporter, individual, etc.), and any other available data that may help determine the intended target content channel.

The analysis compares the origin word cloud against corpora data for each channel to establish an associative array of probability for the top three matching channels in each hierarchal category: top or main channel, primary sub-channel, and secondary sub-channel. The system provides the most-probable selection to the user for confirmation, along with the second and third most-probable choices as alternates.

Further analysis compares the origin word cloud to that of other origin word clouds and stream clouds of streams in the secondary sub-channel to determine the existence of matching tertiary channels. If no matching tertiary sub-channel exists, the system will select two highest weighted words from the origin word cloud as potential titles for a new tertiary sub-channel, and present those words to the user for edit or approval.

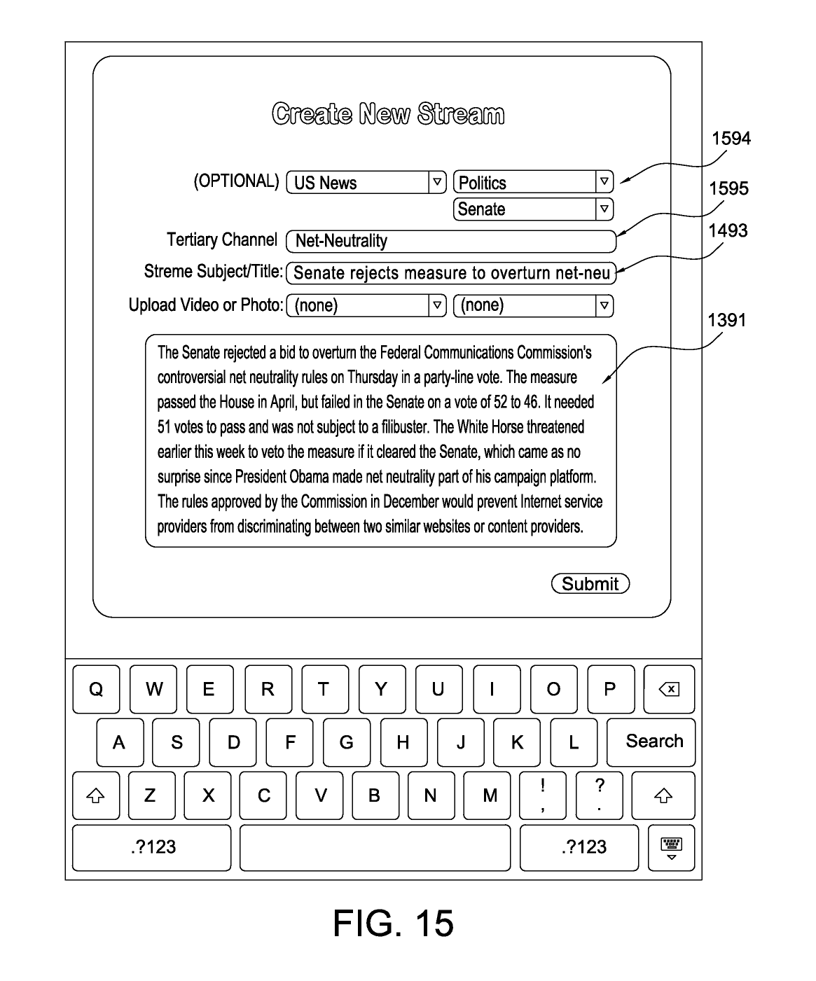

In some embodiments, if the user submitting the new content stream has not indicated any or all of the four primary channels used for content organization, initial content analysis module 321 (FIG. 3) can apply an additional layer of natural language analysis to the origin word cloud, opening sentence, title sub-cloud, and headline. The analysis compares the data to available channels (top/main, primary, secondary, and tertiary) and selects the appropriate channel for the new content. If a corresponding tertiary channel does not exist, the analysis will automatically create the new channel. FIG. 15 illustrates an example of categories 1594 and 1595 generated based upon text 1391, title 1493, and/or origin word cloud 1390 (FIG. 13), according to an embodiment.

In some examples, once the content author accepts either the automatically generated channels, or refines the channels on her own, streams table 881 (FIG. 8) is updated with the new channel information for the new stream. In these examples, the title and categorization can be generated before the user submits the first content element to computer system 300 (FIG. 3).

Next, activity 931 of FIG. 11 includes a procedure 1143 of assigning a content value score to the first content element. In some examples, initial content valuation module 323 (FIG. 3) can assign a content value score to the first content elements at least partially based upon the first weight assigned to each of the one or more components of the first content elements.

Initial content valuation module 323 (FIG. 3) can assign content value scores to each content stream upon creation, and can modify the score based on subsequent user engagement with the content. In some examples, the score value can have a value ranging from 1 to 10, and which is relative to all other content streams. A content stream with a score of 10 will be of the highest possible value within computer system 300, while a stream with a score of 1 will have the lowest assigned value, for example.

Upon submission of a new content stream, initial content valuation module 323 (FIG. 3) can compare all available data of the new stream submission, and assign an estimated initial content score. The initial score is an estimated average, calculated by totaling the current scores of all other recently submitted content streams with a 60% similarity in origin word clouds, then reduced by a factor of one. For example, if a new submission is similar to five other content streams with scores of 5.4, 6.4, 6.5, 7.3, and 7.7, the resulting initial score will be 5.86. In other examples, other procedures can be used to assign a content value score to the first content element. After procedure 1143, activity 931 of FIG. 11 is complete.

Referring again to FIG. 9, method 900 of FIG. 9 subsequently includes an activity 932 of displaying the parent content stream to users. In some examples, content display module 317 (FIG. 3) can display the parent content stream to the user. In some embodiments, the parent content stream can be displayed to user 330, 331, and/or 332 (FIG. 3) on a display of the computer device that the user is using. In one example, FIG. 4 could illustrate a window shown to the user to display the parent content stream before any child content elements are appended to the parent content element.

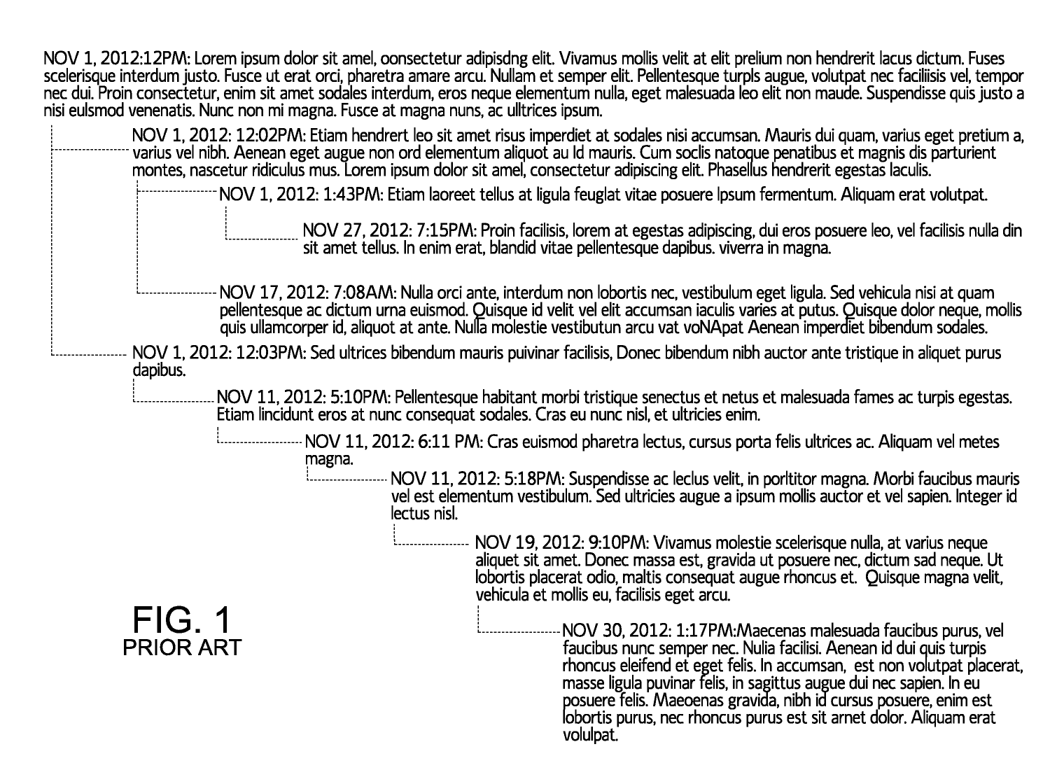

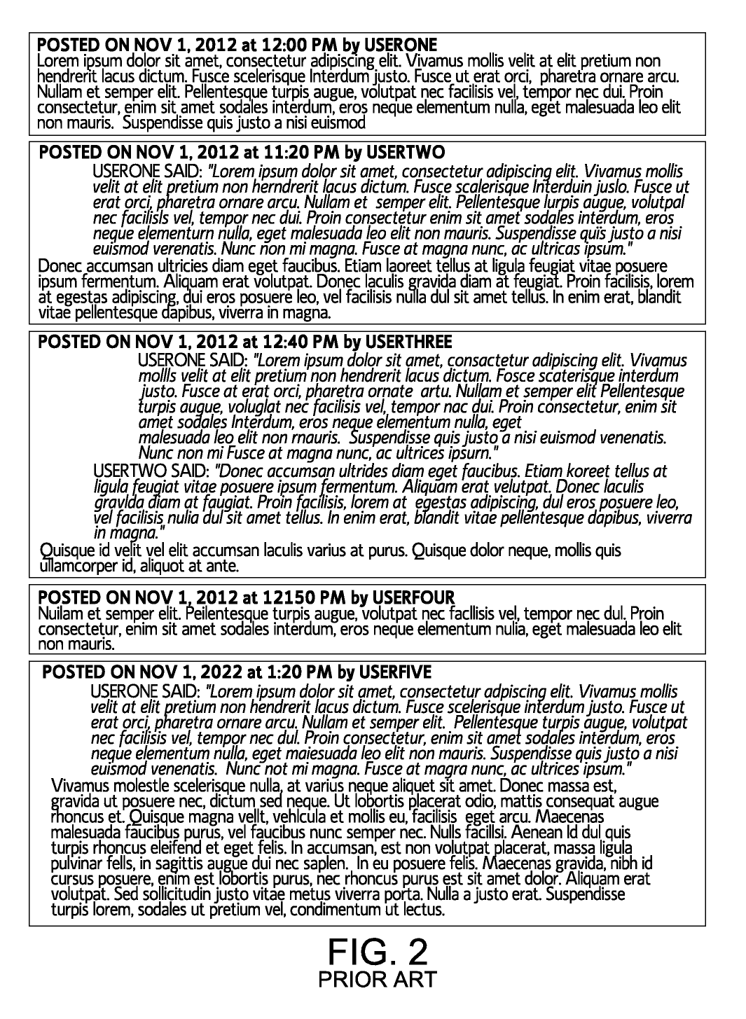

Next, method 900 of FIG. 9 includes an activity 933 to determine whether a new content element has been submitted by a user. In some examples, user interaction module 311 (FIG. 1) can determine if a user 330, 331, or 332 (FIG. 3) has submitted a new content element. If a new content element has been submitted, the next activity is activity 934. If no new content element has been submitted, activity 933 is repeated.

If a new content element has been submitted, the next activity in method 900 of FIG. 9 is an activity 934 of receiving the new content element. In some examples, activity 934 can be similar to activity 930 of receiving a first content element. In many embodiments, user interaction module 311 (FIG. 3) can also give users 330, 331, and 332 (FIG. 3) the ability to indicate that the new content element is related to the first content element. In one example, the user indicates the relationship by clicking on a button, titled “REPLY” when reviewing the first content element and entering the new content element.

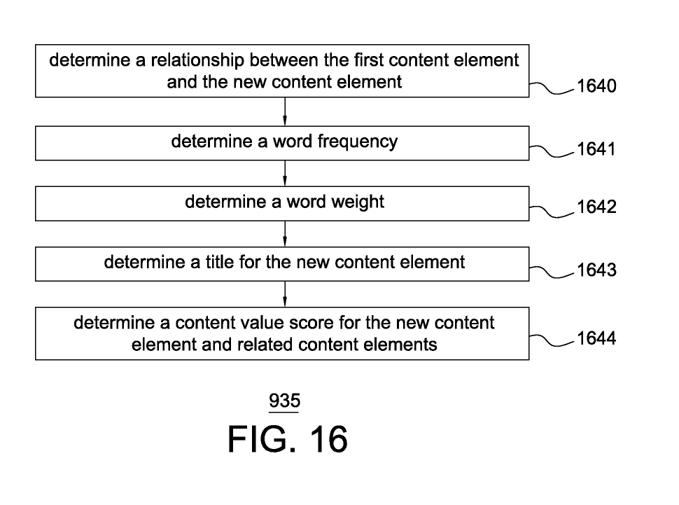

After activity 934, method 900 in FIG. 9 continues with an activity 935 of analyzing the new content element. FIG. 16 illustrates a flow chart for an exemplary embodiment of activity 935 of performing content analysis of the new content element, according to the first embodiment.

Referring to FIG. 16, activity 935 includes a procedure 1640 of determining a relationship between the first content element and the second or new content element. In some examples, ongoing content analysis module 322 (FIG. 3) can determine the relationship between the parent content stream and the new content element. In some examples, a user when submitting the new content element can be a reply button associated with the parent stream (or a child stream). Ongoing content analysis module 322 (FIG. 3) can use the hitting on the reply button as an indication of the parent-child relationship between the two content elements.

Next, activity 935 of FIG. 16 includes a procedure 1641 of determining a word frequency. In some examples, procedure 1641 can be substantially similar to process 1246 of FIG. 12. In many examples, ongoing content analysis module 322 (FIG. 3) can determine the word frequency.

Subsequently, activity 935 of FIG. 16 includes a procedure 1642 of determining a word weight. In some examples, procedure 1642 can be substantially similar to process 1247 of FIG. 12. In many examples, ongoing content analysis module 322 (FIG. 3) can determine the word weight.

Activity 935 of FIG. 16 continues with a procedure 1643 of determining a title for the new content element. In some examples, procedure 1642 can be substantially similar to procedure 1141 of FIG. 11. In many examples, ongoing content analysis module 322 (FIG. 3) can determine the title for the new content element.

Next, activity 935 of FIG. 16 includes a procedure 1644 of determining a content value score for the new content element and related content elements.

In some examples when new content elements are received, content analysis module 315 (FIG. 3) can reassess the content value score of the new content element and related content elements. Content analysis module 315 (FIG. 3) can continue to assess the value of the stream relative to all other streams contained in secondary content channel. Actions and events that will increase the relative score of a content stream area, but not limited to:
Views—each individual view by users, relative to the views on all other content streams in the secondary channel, will increase or decrease the score;
Replies—the addition of new comments and replies to the content stream, relative to the number of comments/replies received by all other content streams in the secondary channel, will increase or decrease the score;
High Priority Replies—content analysis module 315 (FIG. 3) anticipates users will also have a relative score, and that some will be scored higher than other users such that replies or comments from higher scoring users, relative to that in other content streams in the secondary channel, will increase or decrease the score;
Boost—users of the computer system 300 (FIG. 3) will have the opportunity to “boost” the score of a content stream by clicking a “boost” button and the number of boosts relative to all other content streams in the secondary channel, may increase the score;
Reduce—users of the computer system 300 (FIG. 3) will have the opportunity to “reduce” the score of a content stream by clicking a “reduce” button and the number of boosts relative to all other content streams in the secondary channel, may decrease the score. Generally, users will simply ignore topics they do not like; thus, the results of the reduce button are not as significant as that of the boost button by a factor of four in some examples;
Age of Activity—content that remains active, as defined by ongoing views and replies, longer than other content streams in the secondary channel are of higher value than those whose activity is short, thus the period in time in which a content stream solicits views and replies from users will increase or decrease the score. Also, in some examples the age of the content elements in the parent and child content streams can be used to modify the score; and
Advertising Demand—if a content stream receives a high frequency of contextually targeted ads, specifically targeted by advertisers, computer system 300 (FIG. 3) assumes an additional layer of value beyond that of just content consumers, and will increase the score relative to the demand indicated by advertisers.

The essence of the ongoing content valuation, in the form of a content score, provides necessary data to the presentation layer for the proper prioritization of the highest-value content streams within the graphical user interface used to display content to users 330, 331, and 332 (FIG. 3).

In some examples, an effective presentation layer for the computer system 300 (FIG. 3) can categorize with a three-tiered hierarchy dependent on the date of origin, topical content channels, and the assessed value of streams within each channel. To accomplish a satisfying user experience in the presentation layer, content analysis module 315 (FIG. 3) may continually evaluate the relative value of each content stream. As previously discussed, in some examples, the assessed relative value is a score ranging from 1 to 10, with 10 being the stream with the highest assessed score.

In some embodiments, the score for a stream is the result of a formula, recalculated each time there is some form of user engagement, such as reading a post, replying, taking action on an advertisement, an advertiser targeting the stream, and any other current or future action that involves the stream.

One method for ongoing content valuation involves (but is not limited to) the parameters identified above. In such a method, one formula for ongoing valuation, for example, would be as follows:

### Process One: Establish Engagement Value:

Ev=(V+(R·2)+(hpR·3))

### Where:

Ev=engagement value;

V=total views of all posts in the stream;

R=total replies in the stream; and

hpR=total replies from high priority users.

### Process Two: Establish User Scoring Value:

Us=(Bo−(Rd/4))

### Where:

Us=user score;

Bo=total boosts assigned by users; and

Rd=total reductions assigned by users.

### Process Three: Establish Advertiser Value:

ADv=((A+1)/10)·(adR/(V/1000))

### Where:

ADv=advertiser value;

A=total ads targeted to the stream; and

adR=total stream ad revenue.

### Process Four: Create Actual Score:

Asc=Ev·Us·ADv

### Where:

Asc=actual score.

### Step Five: Create Relative Score (1-10):

Rsc=((Asc−Lsc)·Asv)+1

### Where:

Rsc=relative score from 1 to 10;

Lsc=lowest actual score in the system; and

Asv=actual score value, with

Asv=9/(Hsc−Lsc)

Hsc=highest actual score in the system.

The resulting relative score (Rsc) is rounded to three decimal places, and both the actual and relative scores are updated in streams table 881 (FIG. 8). For new content streams less than 2 hours old, in some examples, the initial score value takes priority, and if the calculated Rsc varies by more than 0.025, either higher or lower, the resulting Rsc written to streams table 881 (FIG. 8) is an increment of the initial score, either 0.025 higher, or 0.025 lower depending on the Rsc value.

In some embodiments, the formula may be adjusted, refined, and or include additional value parameters to reflect either business strategies of the implementation, or new realities of user engagement. For example, one evolutionary embodiment may place a score priority or penalty on certain content channels, or a score priority on certain content authors.

As part of procedure 1644, the content score of each of the content elements in any content stream related to the new content element can be updated using the scoring method described above.

In addition to updating the scores when a new content element is received, ongoing content analysis module 322 (FIG. 3) can be configured to update the scores when a predetermined number of interactions with a content element occur or at predetermined intervals. For example, ongoing content analysis module 322 (FIG. 3) can be configured to update the score of a content element whenever a user clicks on the content element to read it, when a new related content element is received, or at a predetermined interval (e.g., one minute, one hour, one day, or one week) if there is no activity or interactions related to the item. After procedure 1644, activity 935 of FIG. 16 is complete.

Referring back to FIG. 9, method 900 in FIG. 9 includes an activity 936 of creating orphan content stream. In the event a new content element is a direct response to a specific element, stream creation module 314 (FIG. 3) can create a unique identifier to establish the orphan stream status. The new orphan identifier is inserted into the orphan_id column when the new record is created in element table 882 (FIG. 8), along with the unique identifier of the element that inspired the reply inserted into the reply_id column.

If the orphaned response solicits a new response from another user, the established unique orphan identifier is used in the orphan_id column of the new element table 882 record corresponding to the new response.

Next, method 900 of FIG. 9 includes an activity 937 of displaying the content streams to users. In some examples, content display module 317 (FIG. 3) can display the parent content stream to the user. In some embodiments, the parent content stream can be displayed to user 330, 331, and/or 332 (FIG. 3) on a display of the computer device that they are using. In one example, FIGS. 4-6 illustrate one way of displaying the content streams to the users

Subsequently, method 900 of FIG. 9 includes an activity 938 of determining whether to create a new content stream. Once a new content stream is submitted and available for public view, stream creation module 314 (FIG. 4) anticipates that additional users will provide follow-up replies and comments. When a new content stream receives a predetermined number of replies (e.g., three or five content elements), stream creation module 314 (FIG. 4) creates a second evolving word cloud composed of all posts or replies within the stream. This secondary word cloud is referred to as the stream word cloud and carries an equal weight of importance to that of the origin word cloud.

Initially, the new content stream is an orphan stream. If the orphan stream does not grow to a predetermined length, method 900 can continue with activity 933. In the event an orphan stream does grow to the predetermined length (e.g., three or five replies), ongoing content analysis module 322 (FIG. 3) can apply an analysis to the content elements that comprise the orphan. The analysis occurs on each new reply, and determines the potential valuation of the orphan stream. Using the analysis, ongoing content analysis module 322 can create a temporary word cloud form the orphan stream, and ongoing content valuation module 324 (FIG. 3) calculates a potential valuation.

If the orphan stream contains at least a first predetermined number of elements (e.g., three or five content elements) and a valuation of more than a predetermined amount (e.g., 75%) of the parent stream, the orphan stream is upgraded to a child stream (e.g., activity 939), using the unique identifier in the orphan_id column of element table 882 (FIG. 8) as the new unique identifier for the new child stream.

If the orphan stream contains a second predetermined number of elements (e.g., six or more content elements), it is upgraded to a child stream regardless of the valuation score.

After activity 939, procedure 1140-1141 (FIG. 11) can be employed to title, value, and classify the new stream. As new replies are received as new elements in the child stream, procedure 1640-1644 (FIG. 16) can be applied for an ongoing analysis and valuation of the child stream.

In various embodiments, ongoing content analysis module 322 (FIG. 3) can perform the initial analysis of the child content elements similar to the analysis of the parent content elements performed by initial content analysis module 321 (FIG. 3). Similarly, ongoing content valuation module 324 (FIG. 3) can determine a content value score of the child content elements similar to the analysis of the parent content elements performed by initial content valuation module 323 (FIG. 3) or by using activities described in activity 935 of FIG. 16.

Once a new stream is available for public view, users may opt to reply to the new stream to provide their own comments, questions, or additional information. Content valuation module 316 (FIG. 3) classifies a new stream as a valuable stream once it achieves a minimum predetermined number of replies. At that point, the second word cloud is generated from all the replies, and updated each time a new reply is posted. The stream cloud is selected in the same manner as the origin cloud, but with the different source data comprised of only replies to the opening posting. The finished word cloud is inserted into stream cloud table 884 (FIG. 8) with a relational indicator of the stream identity, and updated each time a new reply is posted. Referring again to FIG. 9, after activity 939, the next activity in method 900 is activity 930 of determining whether a new content element has been received.

The embodiments of computer system 300 (FIG. 3) and method 900 (FIG. 9) described herein are framework for content organization and display assumed to be part of an integrated platform that includes other systems such as a presentation layer and an application layer as well as any other systems deemed necessary to display content to specific users and devices. Aspects of data dependencies within computer system 300 (FIG. 3) are reliant upon integration with these other layers. An embodiment of such an integrated platform can involve the following:

Application Layer: This component defines the actual content channels, sub-channels, content submission systems, and content management systems available to computer system 300 (FIG. 3), as well as data, including: boosts, reduces, replies, and any other data from other layers required for content organization and valuation.

Presentation Layer: In some examples, this component can provide an intuitive user interface that can be useful to the understanding and utilization of this fundamentally different approach to interrelated user-generated digital content.

Analytics Layer: This component supplies computer system 300 with necessary user engagement parameters, as well as incorporate automated processes for the calculation of historic data points. User engagement parameters would include stream and post views. Historic data points would include daily stream views, daily stream replies, daily relative score averages, and any other data that defines user engagement over the history of a stream.

Advertising Layer: This component supplies computer system 300 with aggregate data about the success of advertiser interest in each individual stream, as well as the advertising revenue generated by each individual stream. Data provided to computer system 300 (FIG. 3) includes total targeted advertisements specified to a stream and the total ad revenue (in actual dollars) generated by a stream.

The embodiment of the computer system described herein can be a core framework for content organization and display that can rely upon an integrated presentation layer to properly represent to users and readers the structure, relationships, and dependencies of content elements within parent and child streams. The presentation layer described herein may be deployed using a variety of technologies including HTML and AJAX methods, and/or self-contained mobile apps developed in the Objective C programming framework.

In some examples, to ensure an efficient and seamless flow of content within the context of the user experience, the presentation layer utilizes a technique of “look ahead” and “look back” content caching. Using elements of the application layer, the method queries element table 882 and streams table 881 (FIG. 8) to obtain the current content being viewed by the reader, as well as a first predetermined number (e.g., one, five, ten, or fifty) content elements ahead in the parent and child streams, and a second predetermined number (e.g., one, five, ten, or fifty) content elements back.

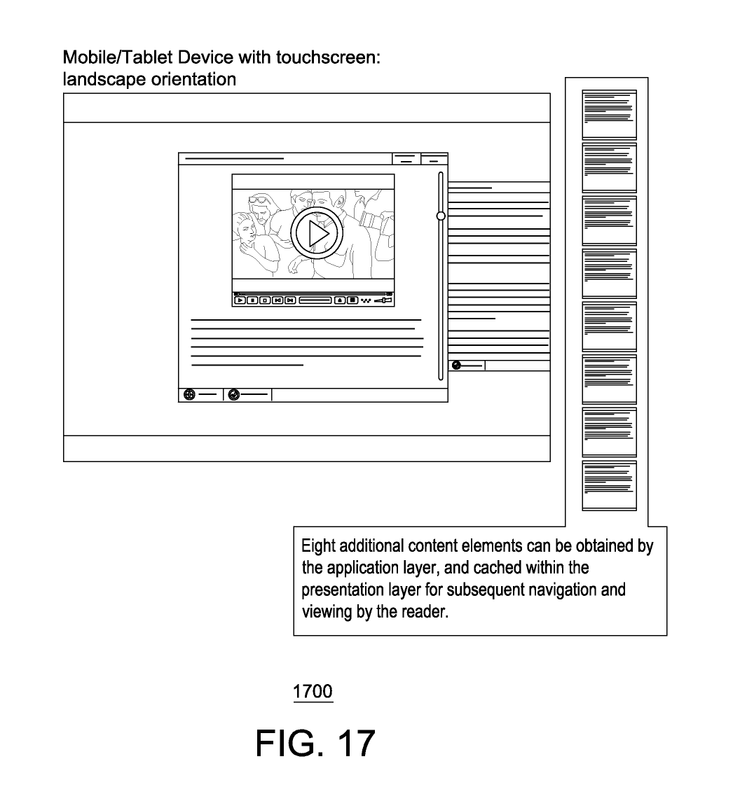

FIG. 17 illustrates an exemplary interface for a computing device with a touchscreen (i.e., a mobile or tablet computing device) that is displaying the content element currently selected by the reader, as well as the look ahead and look back content elements, shown “off screen” for the purposes of illustrating the point. If the reader is accessing the first content element in a parent stream, the application layer can obtain only a predetermined number of look ahead elements, as there are no look back elements.

To ensure an intuitive experience for readers and users within various embodiments, content elements are displayed using a “card” metaphor where each card expresses a visual display of all material as a self-contain contained content element. Supporting media such as images, video players, or audio players are included within the card so that users may view or play the media within the context of the entire content of the element.

The presentation layer for a computing device can take advantage of touch-screen interfaces and gesture commands such as swipe, pinch, and expand. The reader is initially presented with a view of a parent stream with the card representing the opening content element displayed in the center of the screen at full size, with the next card show in reduced size, dimmed, and behind the opening card to the right.

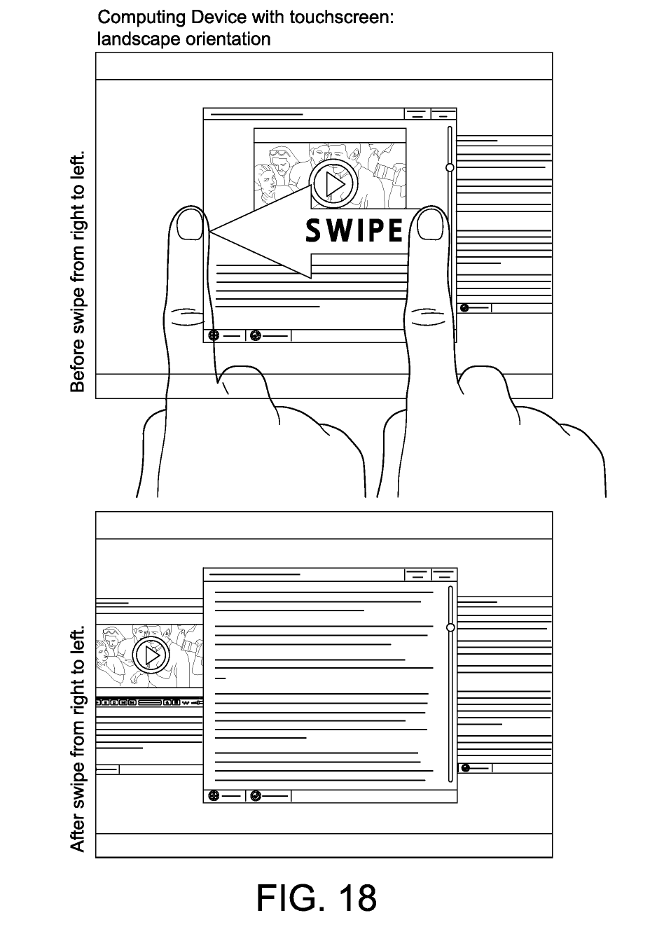

FIG. 18 illustrates an example of a first navigation process between content elements on a computing device with a touchscreen, according to an embodiment. As shown in FIG. 18, to view the next card in a stream, the reader (i.e., the user) needs simply to swipe the screen with her finger from right to left. The presentation layer programming of computer system 300 (FIG. 3) recognizes the command, and corresponds with a brief fluid animation to push the existing card to the left, and bring the next card into center view. The result is the current card being displayed at full size in the center of the computing device screen, with the previous card reduced, dimmed, and behind the current card to the left, with the next card appearing as described above.

In the event the reader wishes to reverse and view again a previous card, she simply swipes from left to right to experience a reverse of the animation result described above.

After each reader action to navigate a stream, the application layer continues content look ahead and look back querying to ensure a cache of available content in the presentation layer for seamless navigation without apparent delay.

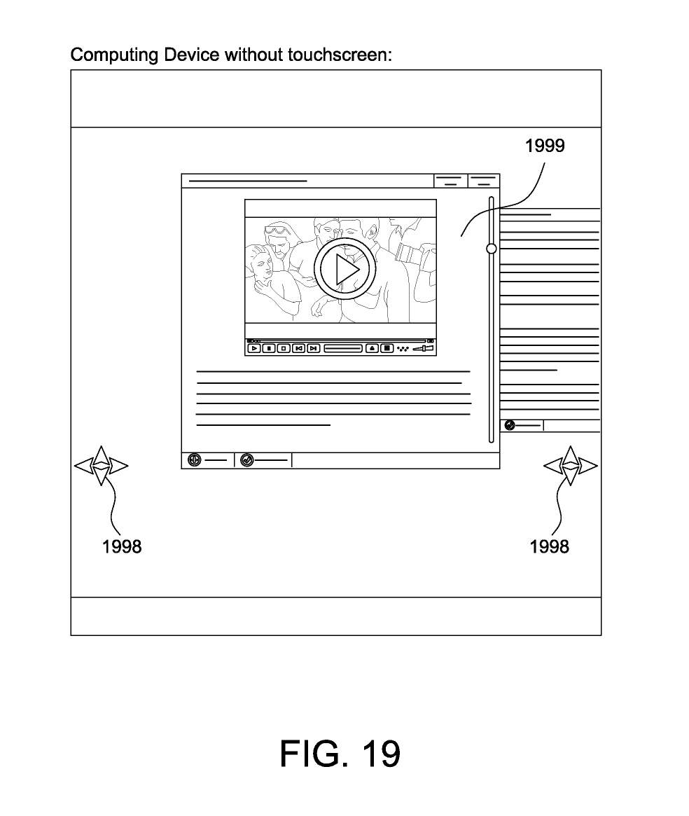

FIG. 19 illustrates an example of a navigation process between content elements on a computing device without a touchscreen (e.g., a desktop or laptop computer), according to an embodiment. As shown in FIG. 19, access via computer devices such as desktop and laptop systems is similar, except that touch screen interfaces are typically not available for user input. The embodiment makes use of on-screen icons to indicate left/right (back/forward) navigation of the content stream, and/or left/right keyboard arrows depending on reader preference. That is, navigation arrows 1998 are provided near ends of the content cards 1999 to allow navigation. The presentation layer for computer devices otherwise functions exactly as described above.

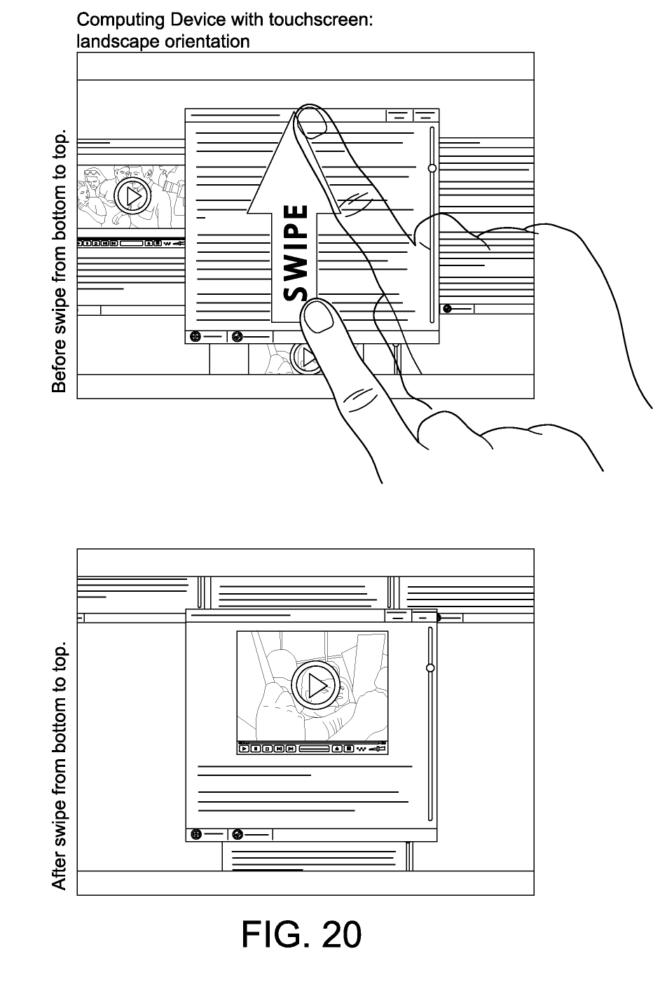

FIG. 20 illustrates an example of a second navigation process between content elements on a computing device with a touchscreen, according to an embodiment. As shown in FIG. 20, when viewing a content card that has spawned an orphan or child stream, the reader can be presented with the card of the child stream in a reduced and dimmed manner, behind the current card at the bottom. To access the card in the orphan or child stream, the user need simply swipe from bottom to top to view an animation as described above, except in a vertical orientation.

The embodiment makes use of on-screen icons to indicate top/bottom (up/down) navigation of the content stream, and/or up/down keyboard arrows depending on reader preference. The presentation layer for computer devices otherwise functions exactly as described above, except through the use of navigation buttons or keyboard arrows.

In both computing devices with or without a touchscreen, the method of encountering new multigenerational child and orphan streams can be identical, with the navigational differences specified above. In the event a second-generation child stream is encountered while vertically scrolling thought the cards of a first generation child stream, the second-generation stream is shown as a series of cards dimmed, reduced, and extending right behind the current card in the first generation child stream. Subsequent generations branch off down or to the right depending on the orientation of the current stream accessed by the reader.

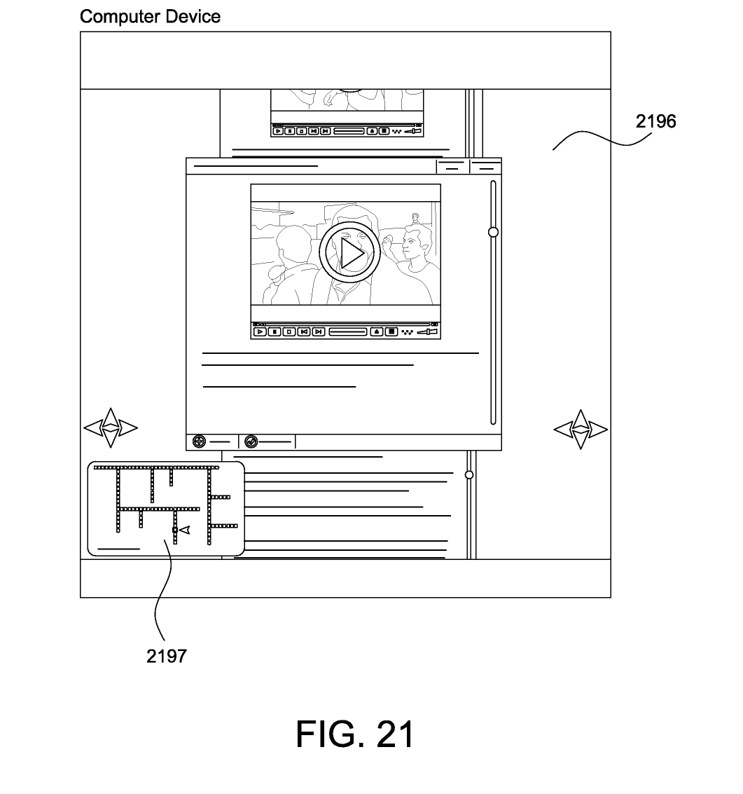

To aid in the semantic awareness of the size, scope, and generational evolution of a stream, readers are presented with a “stream map” that shows the entire stream, representing each content card as small squares. FIG. 21 illustrates an example of an interface 2196 of a computing device with a stream map 2197, according to an embodiment.

In some embodiments, on computing devices, the stream map can be shown in entirety with the currently viewed card shown as highlighted. On tablet devices, desktop computer and laptop computers, a significant portion of the currently viewed section of the stream (in the case of large streams) of the stream map, with the currently viewed card can be shown as highlighted. On mobile devices, a smaller portion (depending on available screen size) of the currently viewed section of the stream map can be shown with the currently viewed card shown has highlighted.

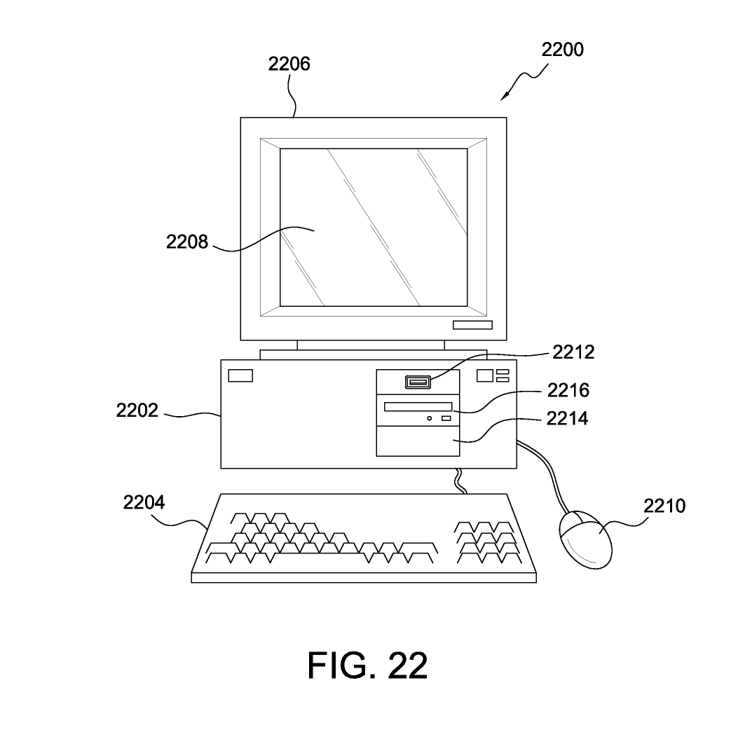

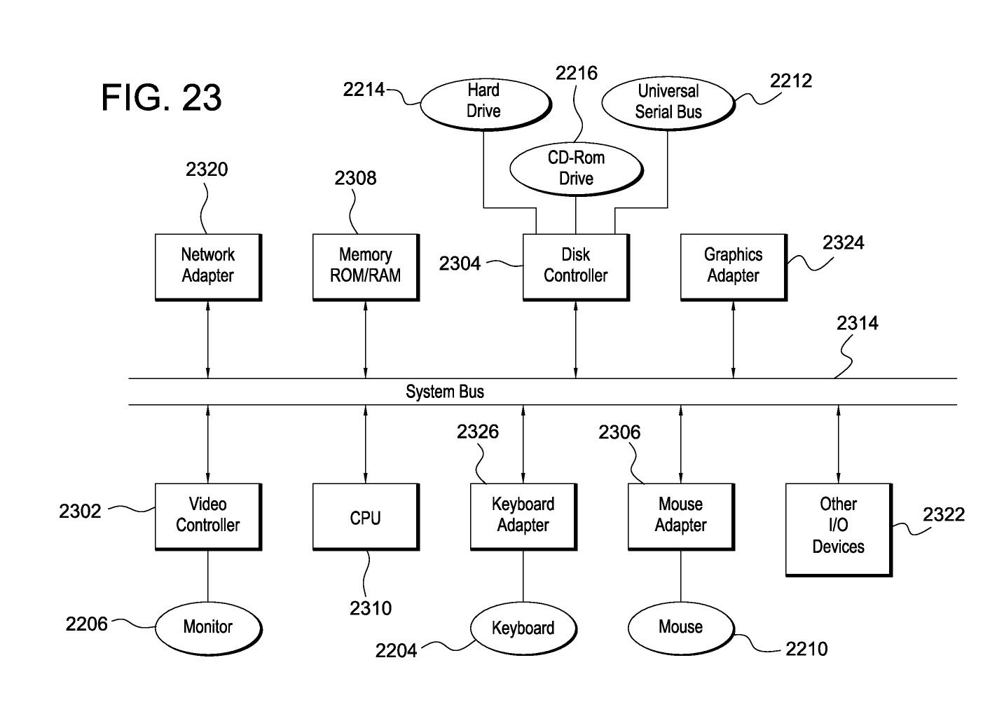

FIG. 22 illustrates a computer 2200 that is suitable for implementing an embodiment of at least a portion of computer system 100. Computer 2200 includes a chassis 2202 containing one or more circuit boards (not shown), a USB (universal serial bus) port 2212, a Compact Disc Read-Only Memory (CD-ROM) and/or Digital Video Disc (DVD) drive 2216, and a hard drive 2214. A representative block diagram of the elements included on the circuit boards inside chassis 2202 is shown in FIG. 23. A central processing unit (CPU) 2310 in FIG. 23 is coupled to a system bus 2314 in FIG. 23. In various embodiments, the architecture of CPU 2310 can be compliant with any of a variety of commercially distributed architecture families.

System bus 2314 also is coupled to memory 2308 that includes both read only memory (ROM) and random access memory (RAM). Non-volatile portions of memory 2308 or the ROM can be encoded with a boot code sequence suitable for restoring computer 2200 (FIG. 22) to a functional state after a system reset. In addition, memory 2308 can include microcode such as a Basic Input-Output System (BIOS). In some examples, memory 302 (FIG. 3) can include non-volatile memory 2308, a USB card in USB port 2212, hard drive 2214, and/or CD-ROM or DVD in ROM or DVD drive 2216.

In the depicted embodiment of FIG. 23, various I/O devices such as a disk controller 2304, a graphics adapter 2324, a video controller 2302, a keyboard adapter 2326, a mouse adapter 2306, a network adapter 2320, and other I/O devices 2322 can be coupled to system bus 2314. Keyboard adapter 2326 and mouse adapter 2306 are coupled to a keyboard 2204 (FIGS. 22 and 23) and a mouse 2210 (FIGS. 22 and 23), respectively, of computer 2200 (FIG. 22). While graphics adapter 2324 and video controller 2302 are indicated as distinct units in FIG. 23, video controller 2302 can be integrated into graphics adapter 2324, or vice versa in other embodiments. Video controller 2302 is suitable for refreshing a monitor 2206 (FIGS. 22 and 23) to display images on a screen 2208 (FIG. 22) of computer 2200 (FIG. 22). Disk controller 2304 can control hard drive 2214 (FIGS. 22 and 23), floppy disc drive 2213 (FIGS. 22 and 23), and CD-ROM or DVD drive 2216 (FIGS. 22 and 23). In other embodiments, distinct units can be used to control each of these devices separately.

Although many other components of computer 2200 (FIG. 22) are not shown, such components and their interconnection are well known to those of ordinary skill in the art. Accordingly, further details concerning the construction and composition of computer 2200 and the circuit boards inside chassis 2202 (FIG. 22) need not be discussed herein.

When computer 2200 in FIG. 22 is running, program instructions stored on a USB drive in USB port 2212, on a CD-ROM or DVD in CD-ROM and/or DVD drive 2216, on hard drive 2214, or in non-volatile memory 2308 (FIG. 23) are executed by CPU 2310 (FIG. 23). A portion of the program instructions, stored on these devices, can be suitable for carrying out method 900 of FIG. 9.

Although the invention has been described with reference to specific embodiments, it will be understood by those skilled in the art that various changes may be made without departing from the spirit or scope of the invention. Accordingly, the disclosure of embodiments of the invention is intended to be illustrative of the scope of the invention and is not intended to be limiting. It is intended that the scope of the invention shall be limited only to the extent required by the appended claims. For example, to one of ordinary skill in the art, it will be readily apparent that activities of FIG. 9 may be comprised of many different activities, procedures and be performed by many different modules, in many different orders, that any element of FIG. 3 may be modified, and that the foregoing discussion of certain of these embodiments does not necessarily represent a complete description of all possible embodiments.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

1. A method of processing information from one or more users, the information is processed using one or more computer processors, the method comprising:
receiving one or more first content elements from the one or more users, each of the one or more first content elements comprises one or more first components;
using the one or more computer processors to perform an initial content analysis of the one or more first content elements to give a first weight to each of the one or more first components of the one or more first content elements;
using the one or more computer processors to assign a first content value score to the one or more first content elements at least partially based upon the first weight assigned to each of the one or more first components of the one or more first content elements;
receiving one or more second content elements from the one or more users;
using the one or more computer processors to assign a second content value score to the one or more second content elements;
using the one or more computer processors to modify the first content value score based upon one or more factors related to the one or more second content elements;
using the one or more computer processors to determine a relationship between the one or more first content elements and the one or more second content elements;
using the one or more computer processors to create a first arrangement of the one or more first content elements and the one or more second content elements at least based upon the relationship between the one or more first content elements and the one or more second content elements, the first content value score of the one or more first elements, and the second content value score of the one or more second content elements; and
displaying the one or more first content elements and the one or more second content elements to the one or more users using the first arrangement.

2. The method of claim 1, further comprising:
using the one or more computer processors to determine a title for each of the one or more first content elements at least partially based upon the first weight assigned to each of the one or more first components of one or more first content elements.

3. The method of claim 1, further comprising:
using the one or more computer processors to determine at least one category for each of the one or more first content elements at least partially based upon the one or more first components of each of the one or more first content elements.

4. The method of claim 1, wherein:
the one or more first components of the one or more first content elements comprise one or more first words; and
using the one or more computer processors to perform the initial content analysis of the one or more first content elements comprises:
determining a word frequency and a word weight of the one or more first words in each of the first content elements to create the first weight for each of the one or more first components of the one or more first content elements; and
performing a natural language analysis of at least a portion of the one or more first words in the one or more first content elements to modify the first weight for each of the one or more first components of the one or more first content elements.

5. The method of claim 4, wherein:
determining the word frequency and the word weight of the one or more first words comprises:
creating a word cloud for each of the one or more first content elements to provide the first weight for each of the one or more first components of the one or more first content elements.

6. The method of claim 4, wherein:
using the one or more computer processors to modify the first content value score comprises:
modifying the first content value score of a first element of the one or more first content elements based upon at least one of:
a number of views by the one or more users of the first element of the one or more first content elements;
a count of the one or more second content elements;
a number of boosts of the first element of the one or more first content elements by the one or more users;
a number of reductions of the first element of the one or more first content elements by the one or more users;
an age of the first element of the one or more first content elements; or
an age of the one or more second content elements.

7. The method of claim 1, further comprising:
using the one or more computer processors to perform an initial content analysis of the one or more second content elements to give a second weight to each of one or more second components of the one or more second content elements,
wherein:
using the one or more computer processors to assign the second content value score to the one or more second content elements comprises:
using the one or more computer processors to assign the second content value score to the one or more second content elements at least partially based upon the second weight assigned to each of the one or more second components of one or more second content elements.

8. The method of claim 1, wherein:
using the one or more computer processors to determine the relationship between the one or more first content elements and the one or more second content elements comprise:
using the one or more computer processors to create an orphan content stream for each of the one or more second content elements; and
using the one or more computer processors to determine whether to create a child content stream for each of the one or more second content elements at least partially based upon the second content value score to the one or more second content elements.

9. A system for processing content from one or more users, the system comprising:
a user interaction module configured to be performed by at least one computer processor and further configured to communicate with the one or more users and receive one or more first content elements and one or more second content elements;
an initial content analysis module configured to be performed by the at least one computer processor and further configured to perform an initial content analysis of the one or more first content elements to assign a first weight to each of one or more first components of the one or more first content elements;
an initial content valuation module configured to be performed by the at least one computer processor and further configured to assign content value scores to the one or more first content elements at least partially based upon the first weight assigned to each of the one or more first components of one or more first content elements;
an ongoing content analysis module configured to be performed by the at least one computer processor and further configured to perform an initial content analysis of the one or more second content elements to assign a second weight to each of one or more second components of the one or more second content elements;
an ongoing content valuation module configured to be performed by the at least one computer processor and further configured to modify the content value score of a first element of the one or more first content elements at least partially based upon the second weight of each of the one or more second components of the one or more second content elements and one or more other factors related to the one or more second content elements and further configured to assign content value scores to the one or more second content elements; and
a content display module configured to be performed by the at least one computer processor and further configured to determine a first arrangement of the one or more first content elements at least partially based upon the content value scores of the one or more first content elements, the content value scores of the one or more second content elements, and a relationship between the one or more first content elements and the one or more second content elements,
wherein:
the user interaction module is further configured to display the one or more first content elements to the one or more users based upon the first arrangement.

10. The system of claim 9, wherein:
the initial content analysis module is further configured to determine a title for each of the one or more first content elements at least partially based upon the first weight assigned to each of the one or more first components of one or more first content elements.

11. The system of claim 9, wherein:
the initial content analysis module is further configured to determine at least one category for each of the one or more first content elements at least partially based upon the one or more first components of each of the one or more first content elements.

12. The system of claim 11, wherein:
the one or more first components of the one or more first content elements comprise one or more first words; and
the initial content analysis module is configured to perform the initial content analysis of the one or more first content elements by: determining a word frequency and a word weight of the one or more first words in each of the one or more first content elements to create the first weight for each of the one or more first components of the one or more first content elements; and performing a natural language analysis of at least a portion of the one or more first words in the one or more first content elements to modify the first weight for each of the one or more first components of the one or more first content elements.

13. The method of claim 9, wherein:
the initial content analysis module is configured to create a word cloud for each of the one or more first content elements to provide the first weight for each of the one or more first components of the one or more first content elements.

14. The system of claim 9, wherein:
the ongoing content valuation module is configured to modify the content value score of a first element of the one or more first content elements based upon at least one of:
a number of views by the one or more users of the first element of the one or more first content elements;
a count of the one or more second content elements;
a number of boosts of the first element of the one or more first content elements by the one or more users;
a number of reductions of the first element of the one or more first content elements by the one or more users;
an age of the first element of the one or more first content elements; or
an age of the one or more second content elements.

15. The system of claim 9, further comprising:
a parent content stream comprises the first content element and the one or more second content elements, wherein:
the content display module is further configured to display the parent content stream to a first one of the one or more users and further configured to cache a predetermined number of the one or more second content elements to be displayed to the first one of the one or more users.

16. The system of claim 9, wherein:
the ongoing content analysis module is further configured to determine the relationship between the one or more first content elements and the one or more second content elements.

17. A method of organizing and displaying two or more content elements using one or more computer processors, the method comprises:
receiving a first content element from one or more users;
creating a parent content stream for the first content element;
displaying the parent content stream to the one or more users;
after displaying the parent content stream, receiving one or more second content elements from the one or more users, the one or more second content elements are related to the first content element;
performing content analysis of the one or more second content elements;
determining whether to create one or more child content streams from the parent content stream based at least partially upon the content analysis of the one or more second content elements;
creating based at least partially upon the content analysis of the one or more second content elements at least one of: the one or more child content streams or one or more orphan content streams; and
displaying to the one or more users the parent content stream and the at least one of the one or more child content streams or the one or more orphan content streams.

18. The method of claim 17, wherein:
the parent content stream comprises the first content element and the one or more second content elements; and
displaying the parent content stream and the at least one of the one or more child content streams or the one or more orphan content streams comprises:
displaying the parent content stream to a first one of the one or more users; and
caching a predetermined number of the one or more second content elements to be displayed to the first one of the one or more users.

19. The method of claim 17, further comprising:
before creating the parent content stream for the first content element, assigning a first content value score to the first content elements at least partially based upon a first weight assigned to each of one or more first components of the first content element.

20. The method of claim 17, wherein:
the one or more second content elements comprise one or more words; and
determining whether to create one or more child content streams comprises:
determining a word frequency and a word weight of the one or more words in each of the one or more second content elements to create a first weight for each of the one or more second content elements; and
performing a natural language analysis of at least a portion of the one or more words in the one or more second content elements to modify the first weight for each of the one or more second content elements.
